(19) United States
(12) Patent Application Publication
(10) Pub. No.: US 2005/0090915 A1
(43) Pub. Date: Apr. 28, 2005

(54) Programmable and expandable building automation and control system

(75) Inventor: John Geiwitz, Albuquerque, NM (US)

Correspondence Address: PEACOCK MYERS AND ADAMS P C, P O BOX 26927, ALBUQUERQUE, NM, 871256927, US

(73) Assignee: Smart Systems Technologies, Inc., Albuquerque, NM (US)

(21) Appl. No.: 10/830,653

(22) Filed: Apr. 22, 2004

(30) Foreign Application Priority Data
Oct. 22, 2002 (WO) PCT/US02/33987

(51) Int. Cl. G06F 17/00

(52) U.S. Cl. 700/90; 700/275

(57) ABSTRACT

A programmable and expandable building automation and control system 10. A system platform supports interchangeable smart card 12, security card 22, power supply card 24, telephone/voice/modem card 26, HVAC relay control 62, auxiliary relay control 66, power 80, telephone interface 30, sensor analog inputs 32, smoke detector interface 54, siren/strobe output 82, tamper loop 52, protected peripheral power supply 72, switched peripheral power supply 74, PLC communication protocol interface 18, RS 232 communication interface 14, RS 485 communication interface 16, touchscreen user interface 28, and “smart” key interface 34 via “smart” key 104. In addition to touchscreen and smart key interface, user-interface with system 10 is accommodated via telephone, personal computer or personal digital assistant, or through infrared or radio frequency transmission.

### CROSS-REFERENCE TO RELATED APPLICATIONS

This application is a continuation-in-part of PCT Application Ser. No. PCT/US02/33987, entitled “Programmable and Expandable Building Automation and Control System,” filed Oct. 22, 2002, which claims priority to U.S. Provisional Patent Application No. 60/339,511, entitled “Programmable and Expandable Building Automation and Control System, filed Oct. 22, 2001.

### BACKGROUND OF THE INVENTION

### FIELD OF THE INVENTION (TECHNICAL FIELD)

The present invention relates generally to the field of systems for the automation and control of building environments, including automation and control of such operations and devices as security, lighting, electrical outlets, energy management, and entertainment. Particularly, the present invention relates to a programmable automation and control system accessible by touch-screen, “smart” key, telephone, Internet, radio frequency and infrared signals.

### NOTICE OF COPYRIGHTED MATERIAL IN DISCLOSURE

A portion of the specification of this patent document contains material that is subject to copyright protection. The copyright owner has no objection to the facsimile reproduction of the patent document as it appears in the Patent and Trademark Office patent file or records, but otherwise reserves all copyright rights whatsoever.

### BACKGROUND ART

Present building automation systems typically consist of a plurality of stand-alone systems for control of a variety of features. For example, a residential security system consists of one or more keypads through which the homeowner interfaces with the system. The user enters a security code through a keypad to arm and disarm the system. Various sensors are located throughout the residence, such as at windows and doors, to monitor the environment of the home. These sensors are connected to a processor which automatically dials a security service or police in response to a particular sensed condition.

As industrial and commercial buildings, as well as residential dwellings, (hereafter referred to by the common term “building”) have become more sophisticated, there has been an increased need for additional automation and control of building operations. Lighting, electrical power outlet, home theater, television and radio, intercommunication between rooms, telephone, and energy management control are becoming increasingly important in building automation. In particular, a need has developed for a building automation system that can control a variety of building operations. Additionally, with the advent of the Internet, mobile wireless communication devices such as cellular telephones and personal digital assistants (PDAs), and personal computers, users increasingly want the ability to control and program the automation system with these devices rather than being limited to interfacing through a keypad, or keypads, located at the building site.

One difficulty with combining automation of a variety of building subsystems is that the subsystems each have a unique set of operating parameters. Another difficulty encountered with such a system is that it is cumbersome or impossible to upgrade as technology advances, making the system prone to becoming obsolete in a relatively short period of time.

Another difficulty encountered when combining control of various subsystems into a single system is a cumbersome user-interface that is difficult for the user to navigate. Users tend to become overwhelmed in dealing with such a system, often which employs a variety of separate keypads. Consequently users may not utilize all available features of the system. Users also experience frustration in attempting to remember and enter a number of security codes and/or passwords to obtain access to system operation.

Patents that disclose control devices for buildings include U.S. Pat. No. 5,218,552 to Stirk et al., entitled, “Control Apparatus for Use in a Dwelling.” This patent refers to a combination of subsystems such as security, HVAC and lighting, that essentially remain separate and modular in nature. The combination of building subsystems in the Stirk patent is accomplished with a variety of individual devices such as modems, multiplexers and connecting blocks so that products made by different manufacturers can be linked together. U.S. Pat. No. 6,029,092 to Stein, entitled, “System and Method for Providing Modular Control and for Managing Energy Consumption,” also discloses linking products made by different manufacturers together through a variety of individual modems, multiplexers and the like. The Stein patent requires a dedicated network and stand-alone computer in order to add any additional features to the system beyond a controlled thermostat. Similarly, U.S. Pat. No. 5,621,662 to Humphries et al., entitled, “Home Automation System,” discloses a system that links subsystems. The Humphries patent does not specify user interface except through a host computer that can be connected to any input/output device that is PC programmable. U.S. Pat. No. 6,297,724 B1 to Bryans et al., entitled, “Lighting Control Subsystem for Use in System Architecture for Automated Building,” discloses a dedicated lighting control system. The Bryans patent requires low voltage “twisted pair” wiring to be installed in place of conventional high voltage wiring. Bryans also requires high voltage interface devices and switch controls circuits to be installed in the building similar to a conventional circuit breaker box. The Bryans patent is limited to the control of lighting. U.S. Pat. No. 5,086,385 to Launey et al., entitled, “Expandable Home Automation System,” refers to a combination of subsystems linked together by modems, multiplexers and the like, similar to the Stirk, Stein and Humphries patents.

An integrated building automation and control system is needed that is easily expandable to control additional building operations as needed over time. Such a system should be compatible with a variety of control and communication protocols used in building automation applications, as well as be easily modified to adapt to future protocols as they gain acceptance. An integrated building automation and control system should be operable from a user-friendly interface that is easily navigated by the user. Such a system would be user-programmable to suit the automation and control needs of any building. An integrated building automation and control system should be operable from a single interface device. Control of building subsystems should originate at a single source rather than linking various subsystems together. Installation of such a system should require minimal installation of additional wiring into existing buildings.

The present invention overcomes the limitations of the prior art and provides each of these features. The present invention provides direct automation and control of lighting, power outlets, security devices, heating, ventilation and air conditioning (HVAC), access to the system, information logging, audio control, energy management, messaging, and time and task management. The system can be accessed through a dedicated touchscreen, “smart” key reader, Internet interface, telephone interface, computer interface, personal digital assistant interface, or radio frequency (rf) or infrared remote control. The present invention provides control of building subsystems and devices from a microprocessor embedded in an open architecture system platform, and is readily expandable to accommodate additional control and automation needs.

### SUMMARY OF THE INVENTION (DISCLOSURE OF THE INVENTION)

The present invention is a programmable and expandable building automation system. The system comprises an open architecture system platform for control and support of interchangeable cards including a security card, power supply card, telephone/voice/modem card, smart card, and a variety of expansion modules. The smart card comprises an embedded high-speed programmable microprocessor for control of building subsystems and devices. Expansion modules are insertable into expansion ports on the system platform for additional building control and automation. The system platform receives analog inputs from sensor devices for monitoring building environments, building features, subsystems, and devices. Relays controlled by the system platform provide control of building subsystems and devices.

A touchscreen or smart key access apparatus is used for user-interface with the system. The system platform interfaces with the touchscreen, smart key access apparatus, a personal digital assistant or Palm Pilot, or personal computer via an RS 232 interface, RS 485 interface, telephone modem, data bus via an expansion port, or by infrared or rf transmission and reception. The system also sends and receives signals via a PLC interface. Interface with building subsystems and devices, as well as interface among system cards and components, is accomplished via RS 232 protocol, RS 485 protocol, telephone modem, PLC protocol, data bus, or standard wiring.

The present invention is also a smart key access apparatus comprising a smart key for transmitting an encoded signal and a key reader for receiving the encoded signal from the smart key when the smart key is in proximity to the key reader. The key reader sends the encoded signal to the system platform as well as receives control signals from the system platform.

A primary object of the present invention is to provide a building automation and control system that is programmable. Another primary object of the present invention is to provide a building automation and control system that is readily expanded to accommodate additional building subsystems and devices. Another primary object of the present invention is to provide direct control of building subsystems or devices from a system platform without linking subsystems and devices together. Yet another primary object of the present invention is to provide building automation and control by way of user-friendly access to a building automation and control system.

A primary advantage of the present invention is open architecture that allows the system to be readily modified, expanded, or repaired. Another primary advantage of the present invention is that system modularity and remote diagnostic capability reduces warranty and support costs to the user. Another primary advantage of the present invention is that building subsystems and devices are controlled directly from the system platform and need not be linked together. Yet another primary advantage of the present invention is that a user can access and interact with the system from user-friendly interfaces, as well as access and interact with the system from remote locations.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate a preferred embodiment of the present invention and, together with the description, serve to explain the principles of the invention. The drawings are not to be construed as limiting the invention.

FIG. 1 is a schematic diagram of the preferred embodiment of the present invention for a building automation and control system;

FIG. 2a is a schematic of analog inputs 1-16 to the system platform of the preferred embodiment of the present invention;

FIG. 2b is a first portion of a schematic of analog inputs 17-20, tamper loop input, siren supervisor loop, and the smoke or heat detector interface to the system platform of the preferred embodiment of the present invention;

FIG. 2c is a second portion of the schematic of FIG. 2b;

FIG. 3a is a first portion of a schematic of the telephone interface circuitry of the preferred embodiment of the present invention;

FIG. 3b is a second portion of the schematic of FIG. 3a;

FIG. 4a is a first portion of a schematic of HVAC zone control and auxiliary relays of the preferred embodiment of the present invention;

FIG. 4b is a second portion of the schematic of FIG. 4a;

FIG. 5 is a schematic of an expansion port of the preferred embodiment of the present invention;

FIG. 6 is a schematic of the RS 232 to PLC input/output circuit of the preferred embodiment of the present invention;

FIG. 7 is a schematic of the system reset circuit of the preferred embodiment of the present invention;

FIG. 8 is a schematic of system status indicators of the preferred embodiment of the present invention;

FIG. 9 is a schematic of the door bell interface circuit of the preferred embodiment of the present invention;

FIG. 10 is a schematic of the RS 485 interface circuit of the preferred embodiment of the present invention;

FIG. 11a is a first portion of a schematic of the signal management processor circuit on the system platform of the preferred embodiment of the present invention;

FIG. 11b is a second portion of a schematic of the signal management processor circuit on the system platform of the preferred embodiment of the present invention;

FIG. 11c is a third portion of a schematic of the signal management processor circuit on the system platform of the preferred embodiment of the present invention;

FIG. 11d is a fourth portion of a schematic of the signal management processor circuit on the system platform of the preferred embodiment of the present invention;

FIG. 12a is a first portion of a second schematic of the signal management processor circuit on the system platform of the preferred embodiment of the present invention;

FIG. 12b is a second portion of a second schematic of the signal management processor circuit on the system platform of the preferred embodiment of the present invention;

FIG. 12c is a third portion of a second schematic of the signal management processor circuit on the system platform of the preferred embodiment of the present invention;

FIG. 12d is a fourth portion of a second schematic of the signal management processor circuit on the system platform of the preferred embodiment of the present invention;

FIG. 13 is a schematic of two “smart” key reader/drivers of the preferred embodiment of the present invention;

FIG. 14 is a perspective view of the touchscreen of the preferred embodiment of the present invention;

FIG. 15 is a schematic of the touchscreen embedded controller circuit of the preferred embodiment of the present invention;

FIG. 16a is a front view of a key reader with face plate of the preferred embodiment of the present invention;

FIG. 16b is a front perspective view of a “smart” key that communicates with the key reader of FIG. 16a;

FIG. 17 is the key reader assembly of FIG. 16a;

FIG. 18 is a schematic of the circuitry of the key reader of FIG. 16a;

FIG. 19 is a first portion of a schematic of the telephone/modem/voice card of the system platform of the preferred embodiment of the present invention;

FIG. 20 is a second portion of a schematic of the telephone/modem/voice card of the system platform of the preferred embodiment of the present invention;

FIG. 21 is a schematic of the microprocessor circuit of the system platform of the preferred embodiment of the present invention;

FIG. 22a is a schematic of the connector between the smart card and system platform of the preferred embodiment of the present invention;

FIG. 22b is a schematic of external memory for the smart card of the preferred embodiment of the present invention;

FIG. 22c is a schematic of the real-time clock circuit of the preferred embodiment of the present invention;

FIG. 23a is a schematic of a programmable logic device for the smart card of the preferred embodiment of the present invention;

FIG. 23b is a schematic of the signal bus controlling circuit for the smart card of the preferred embodiment of the present invention;

FIG. 24a is a schematic of a programmable logic device for cyclic redundancy checking between the smart card and system platform of the preferred embodiment of the present invention;

FIG. 24b is a schematic of a dual asynchronous receiver transmitter for RS 232 ports of the preferred embodiment of the present invention;

FIG. 24c is a schematic of memory of the preferred embodiment of the present invention;

FIG. 25 is a schematic of the power supply card of the preferred embodiment of the present invention;

FIG. 26 is a first portion of a schematic of the security card of the preferred embodiment of the present invention;

FIG. 27 is a second portion of a schematic of the security card of the preferred embodiment of the present invention;

FIG. 28 is a schematic of the audio expansion module embedded controller and RS 485 control circuit of the preferred embodiment of the present invention;

FIG. 29 is a schematic of the audio expansion module input/output 8-channel digital to analog converter circuit of the preferred embodiment of the present invention;

FIG. 30 is a schematic of the audio expansion module source select circuitry of the preferred embodiment of the present invention;

FIG. 31 is a schematic of the audio expansion module interface control circuitry of the preferred embodiment of the present invention;

FIG. 32 is a schematic of the audio expansion module infrared signal decode and routing circuitry of the preferred embodiment of the present invention;

FIG. 33 is a schematic of the audio expansion module interface buffer circuits and audio source status indicators of the preferred embodiment of the present invention;

FIG. 34 shows an HVAC expansion card;

FIG. 35 shows an audio interface;

FIG. 36 shows a remote temperature card and sensor;

FIG. 37 shows a remote temperature sensor; and

FIG. 38 shows a fanless power supply.

### DESCRIPTION OF THE PREFERRED EMBODIMENTS

### (BEST MODES FOR CARRYING OUT THE INVENTION)

I. System Overview

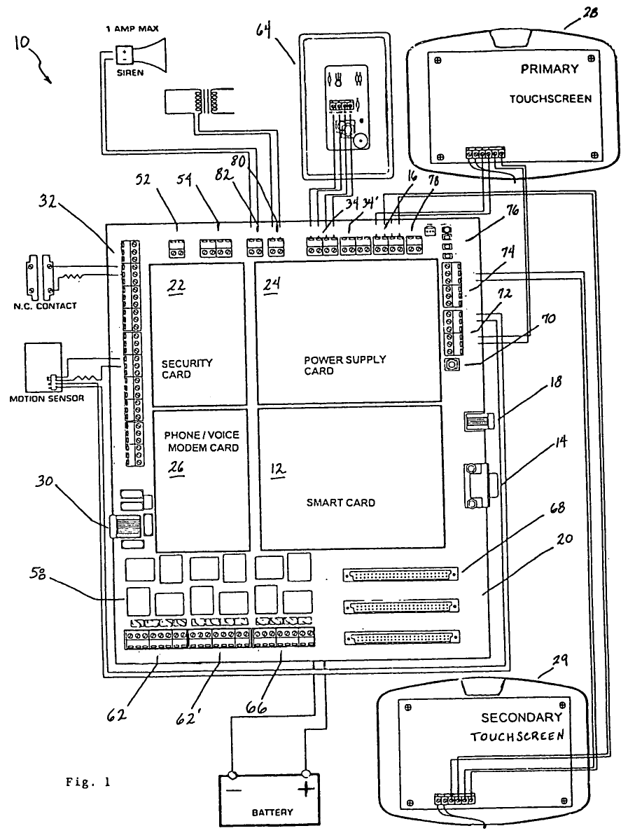

Referring to FIG. 1, a schematic diagram of the present invention for a building automation and control system 10 is shown. With reference to FIG. 1, system components are described generally. The core of the system is a purpose-built, real-time microprocessor controller, or “smart” card, 12 that is programmable either on-site or remotely. Smart card 12 is driven by software and firmware. The platform of system 10 is a modular, open architecture that conforms to industry standards for interoperability and has a Windows software interface accessible by personal computer or mobile communication device, such as a personal digital assistant (PDA).

System 10 conforms to a variety of communication and control protocols for building automation and control via interfaces such as RS 232 interface 14, RS 485 interface 16, power line carrier (PLC) interface 18, as well as communication over conventional “firewire”. System 10 is not limited to communication via these protocols, and is readily adaptable to future control protocols or protocols currently not in use, such as CEBus, SCP and Echelon, Leviton Extended Code, ACT Extended Code and Smart Link Code, by way of expansion ports shown generally at 20.

RS 485 interface 16 and associated “smart” data bus communicate with one or more touch screens 28, 29, “smart” key readers 64, and a variety of other interface devices, such as card readers, keypads, monitors and displays, and other input/output devices.

The core control cards of system 10 are security card 22, power supply card 24, telephone/modem/voice card 26, and interchangeable “smart” card 12. Touch screen 28 (shown from the rear in FIG. 1) interface employs familiar icon-based menus so that the user can interface with and navigate through system 10 in an efficient and user-friendly manner. In addition to touch screen 28, user-interface to system 10 is provided through “smart” key reader unit 64, telephone/modem/voice card 26, an Internet interface expansion module, personal data assistant (PDA), or Palm Pilot interface expansion module, and infrared and radio frequency (rf) interface expansion module.

Software enables system 10 to be controlled, uploaded to, downloaded from, diagnosed, serviced and upgraded via a standard telephone line through telephone interface 30, high speed Internet connection, or direct connection of a personal computer to the system platform.

Expansion modules (not shown in FIG. 1) are insertable into expansion ports 20 to extend the automation and control abilities of system 10. In addition to the user-interface expansion modules listed above, other expansion modules include: an audio expansion module, security expansion module, expanded processor module, expanded HVAC module, remote temperature sensors module, rf interactive energy management module, current transformer energy management module, and expanded code module.

The system receives power 80 from standard 120 VAC passed through a 16.5 V transformer. Protected power output distribution circuit 72 provides power to peripheral devices connected to the system in the event of a power outage. Switched power output distribution circuit 74 provides power to peripheral devices at all times except in the event of a power outage. A battery backup provides power to system 10 transparently in the event of power failure. Siren/strobe output 82 drives a siren and/or a strobe to provide audio-visual alerts to building occupants as directed by the system.

System 10 is now described further with reference to FIGS. 1-33.

II. System Platform

The system platform functions as the back plane of system 10 allowing signals to travel within the system between platform subsystems and expansion modules via connection headers provided for the docking of the modules. The platform also provides connectors for peripheral input/output, or external signals to and from building subsystems such as audio systems, HVAC systems, security systems, and energy management systems, and devices such as building appliances, motorized control devices, solenoids, transducers, lighting, power outlets, alarms, and relays. The invention is not limited to interface and control of these named subsystems and devices, but includes others. “Subsystems” is defined here as systems operating in or in connection with the building in some manner, and “devices” is defined here as devices operating in or in connection with the building in some manner.

The system platform is controlled by a “smart” card, or programmable smart card 12 that operates preferably at 33 MHz or above. Microprocessors suitable for system 10 will be apparent to those of skill in the art. For instance, a suitable microprocessor for operation in accordance with the principles of the invention includes the commercially-available Intel® 386ex processor in combination with an M-Systems® disk-on-a-chip. The processing power, memory capabilities, and input/output requirements of smart card 12 are determined by the particular application for the system. Smart card 12 can be disconnected from the system platform and another microprocessor inserted in its place if necessary, to alter the capabilities of the system. Once inserted onto the system platform, smart card 12 automatically updates the icons and menus of touch screen 28 as appropriate.

Multiple analog inputs 32 are provided to the system platform for input from devices such as door and window contacts, motion detection sensors, gas sensors, stress and pressure sensors, pressure differential sensors, internal and external temperature sensors, water and moisture sensors, vehicle detection sensors, vibration sensors, wind, rain and humidity sensors, occupancy detection sensors, and glass breakage sensors. Although the figures depict twenty such inputs, the principles of the invention are not limited to any specific number of analog inputs as will be understood by those of skill in the art.

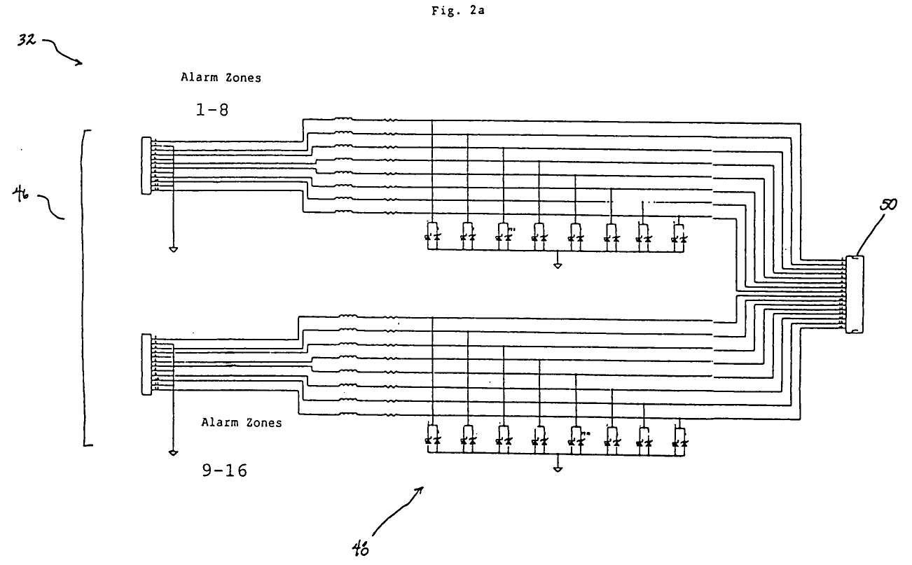

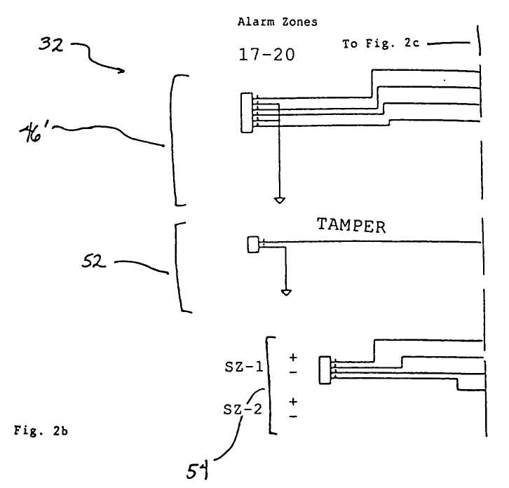

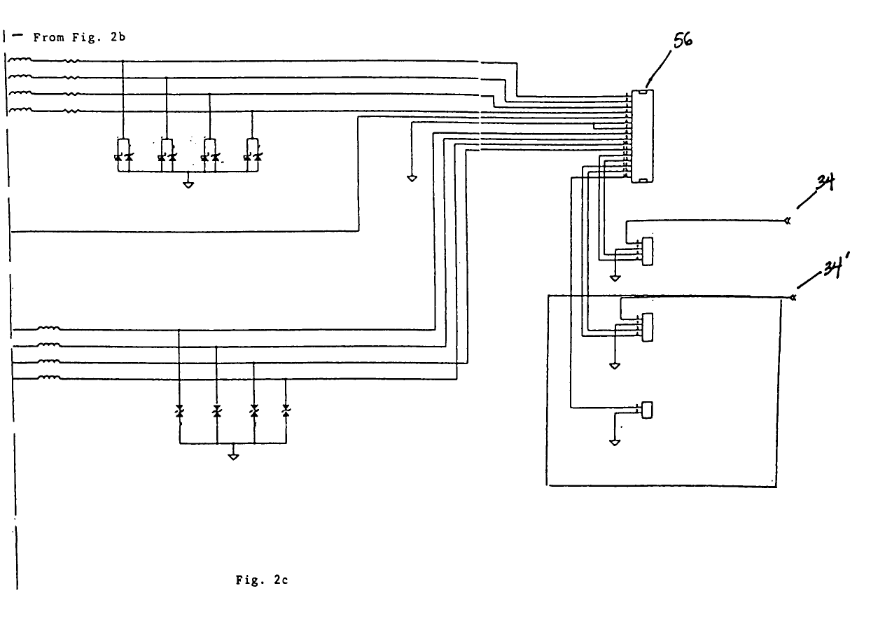

Referring to FIGS. 2a, 2b and 2c, a schematic of analog inputs 32 are shown. FIG. 2a shows a plurality of security zone analog inputs 46 received from sensor devices and corresponding input protection circuitry 48 connected to input socket 50 for predetermined security zones throughout the building. FIGS. 2b and 2c show an additional plurality of security zone inputs 46′ as well as tamper loop input 52. Tamper loop input 52 detects tampering of critical system components. The tamper loop supervises a consistent voltage level of any device that is exposed on the outside of the building such as a siren, telephone line, or strobe light, so that an alarm is tripped in the event these devices are tampered with, disconnected or damaged. Smoke or heat detector interface 54 provides interface with smoke or heat detectors. Two “smart” key reader interfaces 34 and 34′ are shown input to the same connection socket 56 as security zone inputs 46′, tamper loop input 52 and smoke or heat detector interface 54.

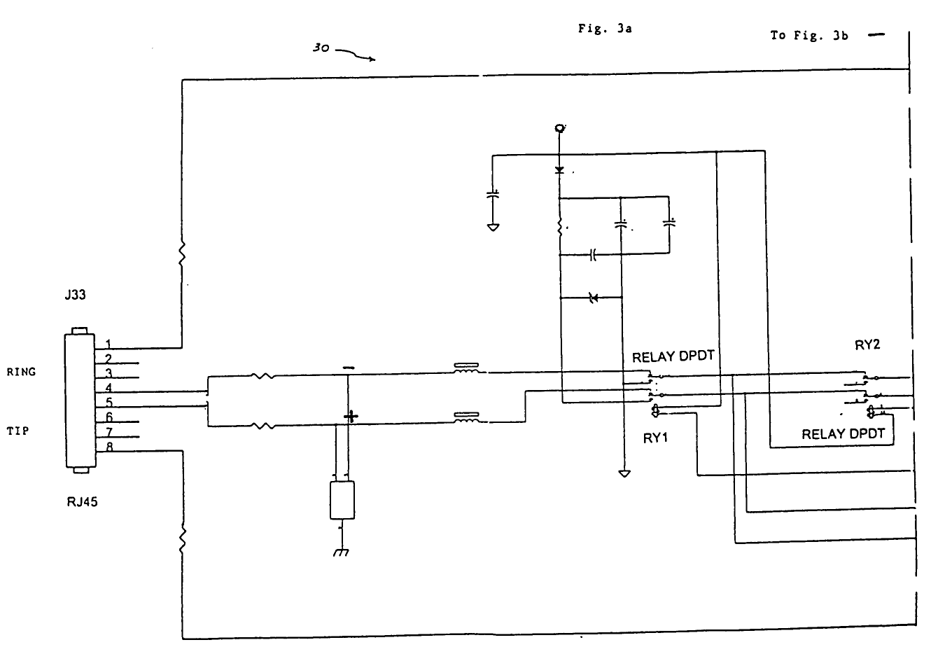

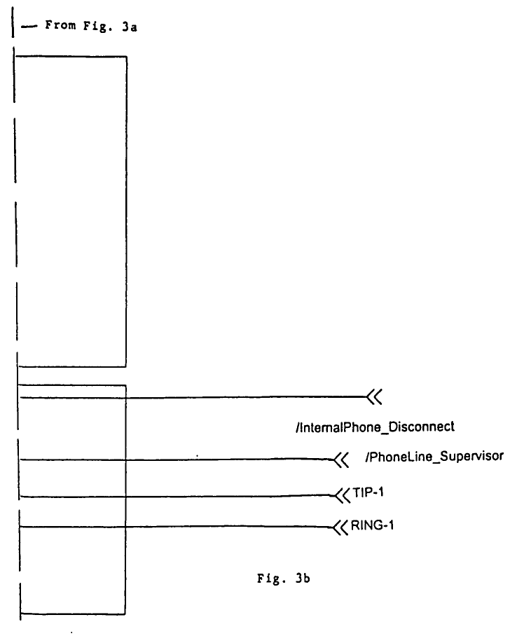

Referring to FIGS. 3a and 3b in combination, a schematic of telephone interface circuitry 30 is shown. Telephone interface 30 disconnects the telephone from the main telephone company and supports the telephone from the system in the event that the user enters a predetermined code on the telephone. Telephone interface 30 provides for auto-dialing in the case of an emergency or user-programmed event, for example, extreme temperature or over-use of energy. Telephone interface 30 also provides the ability to connect to the Internet via a modem connection.

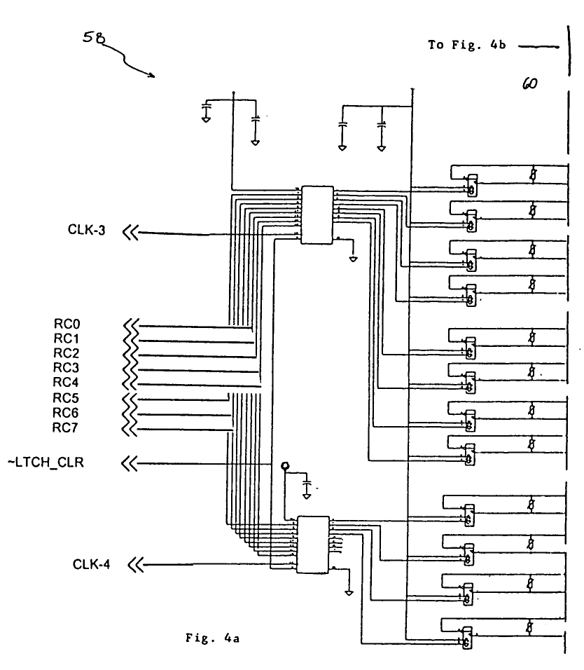

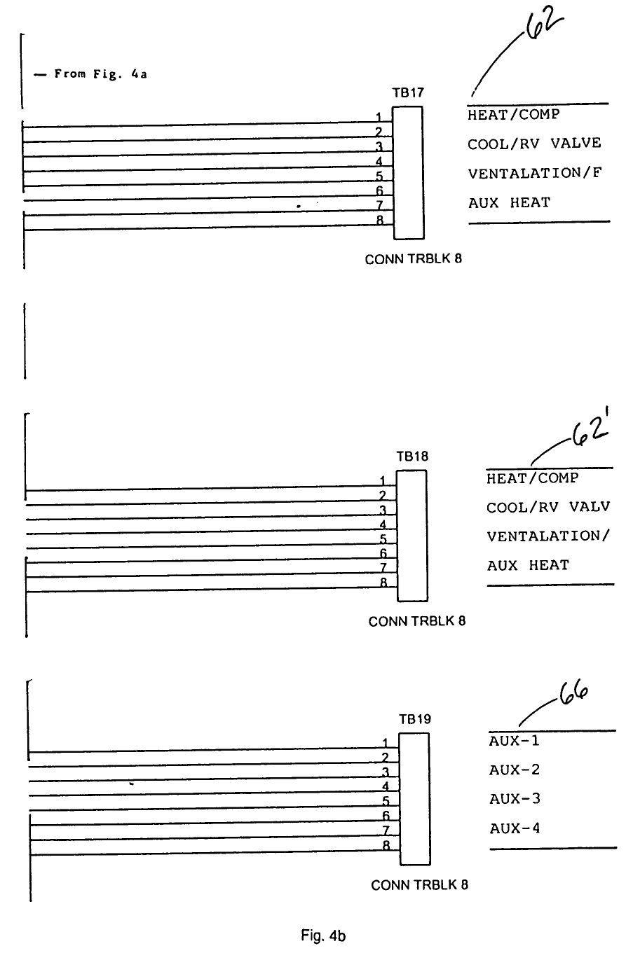

Referring to FIGS. 4a and 4b in combination, a schematic of HVAC zone control and auxiliary relays 58 is shown. (See also FIG. 1.) HVAC inputs interface with the system through relays shown generally at 60. Relays 60 can comprise single-pole, single-throw (SPST) or single-pole, double-throw (SPDT) or other switching devices as will be apparent to those of skill in the art. Relays 60 are de-energized upon loss of main power to the system. Two HVAC zones 62 and 62′ provide interface with two separate zones of HVAC equipment within the building. Auxiliary relays 66 provide control of additional peripheral devices such as solenoids, magnetic door latches, sprinkler and irrigation systems, motor devices such as motorized garage door openers, window coverings and window openers, projector screens and lifts, and devices that are activated via contact closure. Additional auxiliary relays can be added for control of additional peripheral devices via the expansion ports 20.

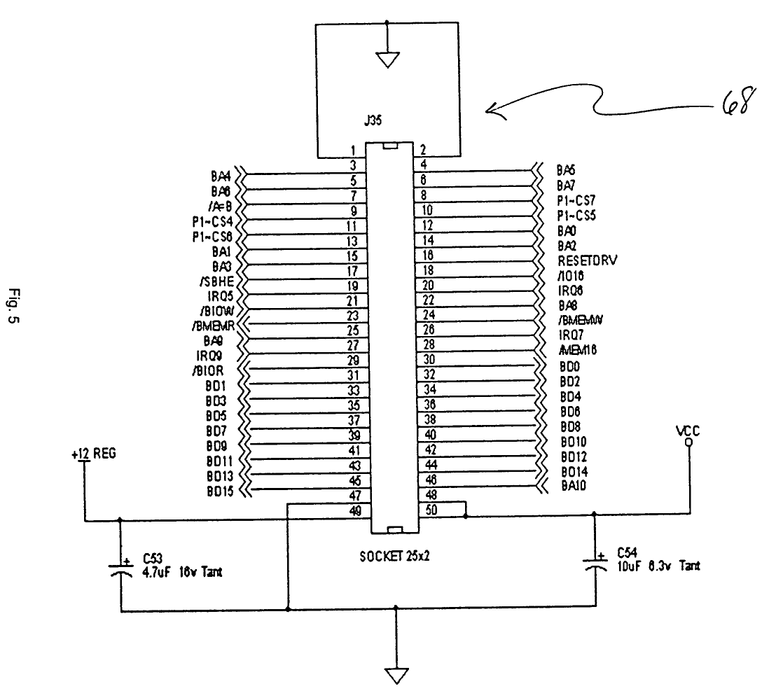

Referring to FIG. 5, a schematic of an expansion port 68 is shown. Expansion port 68 is one of multiple expansion ports 20 on the system platform shown in FIG. 1. Expansion ports 20 are provided to expand the system capabilities as needed for a particular application by connecting any of a variety of expansion modules. Internet interface expansion module, personal data assistant (PDA) interface expansion module, and infrared and radio frequency (rf) interface expansion module are insertable into expansion ports 20 to extend the automation and control abilities of system 10. Other expansion modules include: a peripheral power module, security expansion module, expanded processor module, expanded HVAC module which provides additional relay control of peripheral HVAC devices, remote temperature sensors module, rf interactive energy management module, current transformer energy management module, and expanded code module.

The expanded processor module provides additional processing capabilities including processing power, system memory, input/output signal and data routing, and firmware for the system. The peripheral power module provides power to peripheral sensors and devices that do not derive power from the main power supply of the system. The peripheral power module preferably supplies at least two amperes of electrical current and incorporates surge protection and circuit isolation that protects the system telephone line connection. This module can be readily disconnected from the expansion port and replaced in the event of a power surge or lightning-related system failure. Upon inserting any of the expansion modules into expansion port 68, the expansion module is immediately in bi-directional communication with smart card 12.

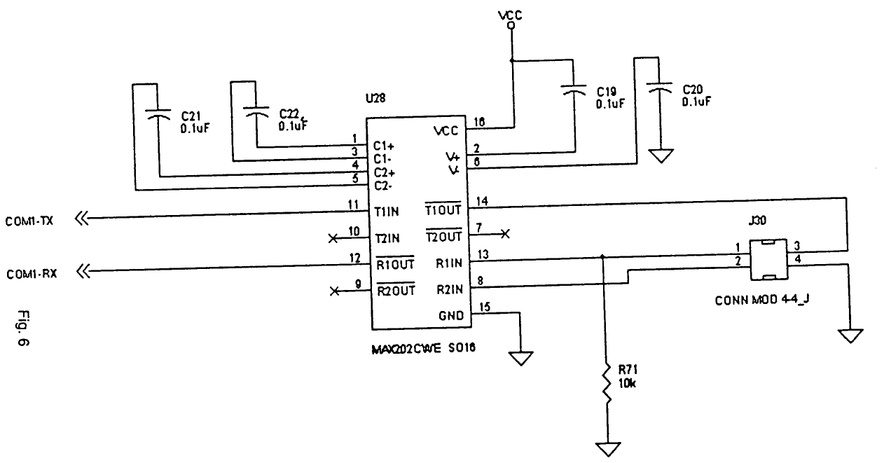

Referring to FIG. 6, a schematic of the RS 232 to PLC data distribution circuit for PLC interface 18 is shown (see also FIG. 1). This circuit is used to convert from RS 232 to PLC protocol and vice versa. PLC interface 18 enables signals to be output from, and input to, existing power lines in a building. The ability to communicate intelligent signals over existing power lines increases the flexibility of the system by decreasing the amount of additional wiring required to install the system. In particular, lighting and outlets can be controlled by PLC signals generated at the system platform. RS 232 interface 14 is connected to an RS 232 data bus for linking, downloading, uploading diagnosing and remote servicing of system 10.

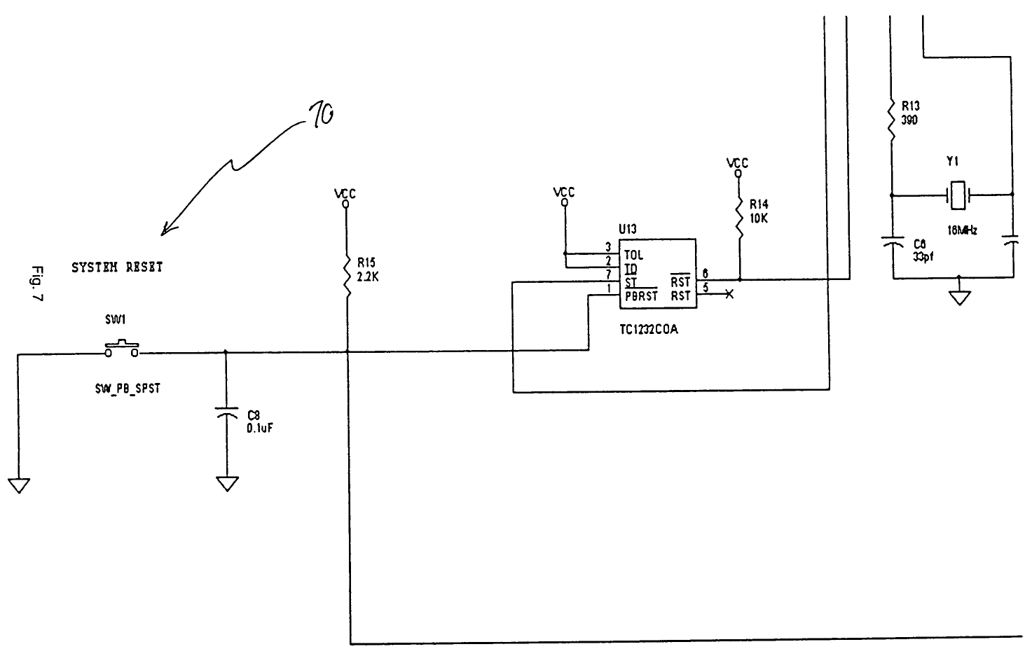

Referring to FIG. 7, a schematic of the system reset circuit 70 is shown. System reset circuit 70 is provided for the hard re-boot of all sub-systems.

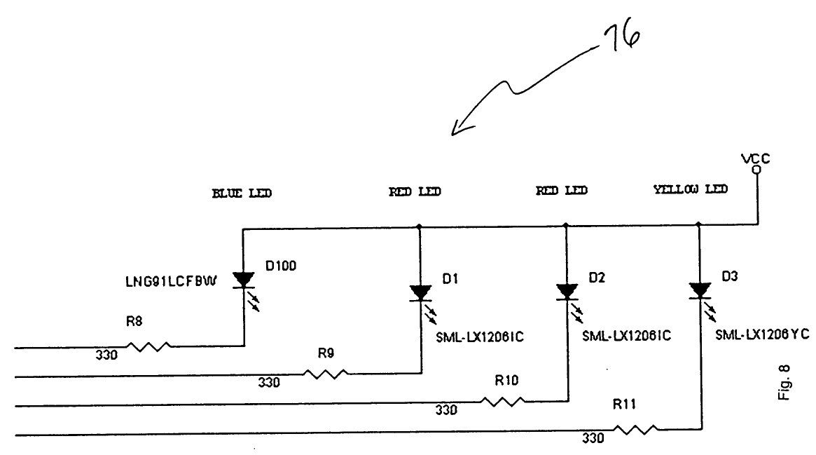

Referring to FIG. 8, a schematic of system status indicators 76 is shown. System status indicators 76 comprise multiple light emitting diodes (LEDs), such as red, blue and yellow LEDs. Indicators 76 provide feedback to the installer or user of the system regarding the condition of power and system battery back-up status, as well as alert the installer or user to system inoperation.

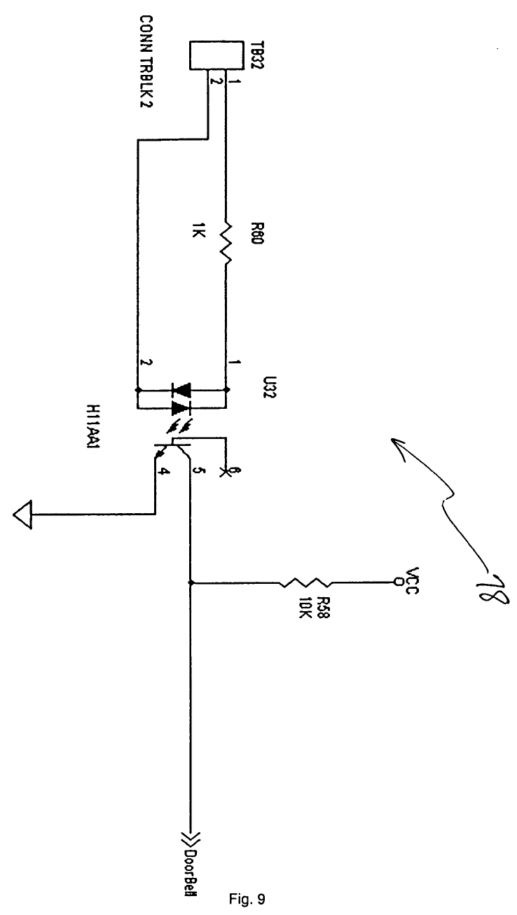

FIG. 9 is a schematic of the door bell input interface circuit 78 to the system. Opto-isolated door bell, or door station, circuit 78 triggers interaction between visitors to the building and the system.

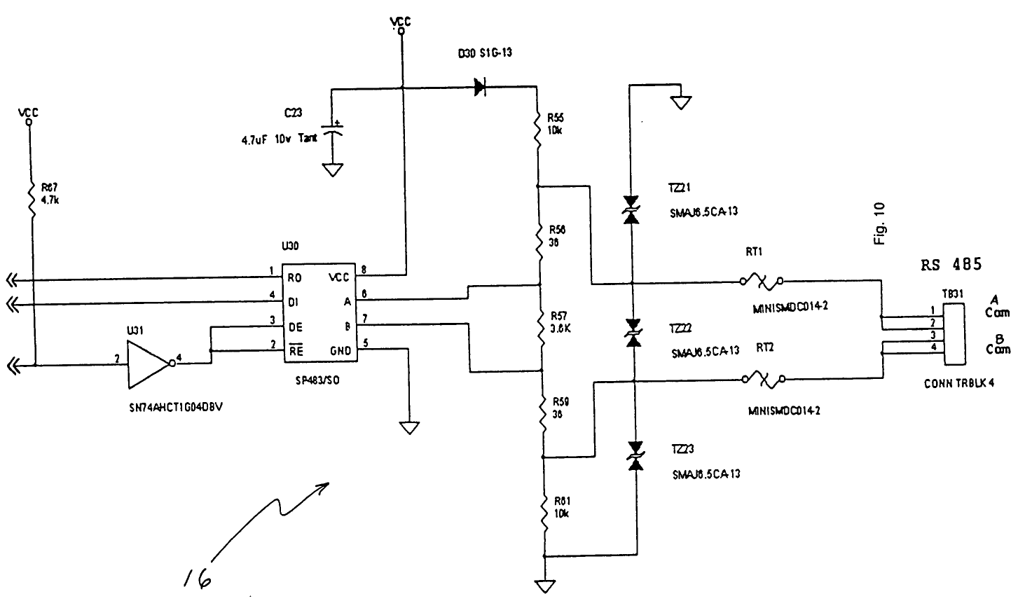

FIG. 10 is a schematic of the RS 485 interface circuit 16. RS 485 circuit 16 allows high-speed communication to and from system 10 on the system “smart” bus. Graphics and video information are also transferred via RS 485 circuit 16 on the system smart bus.

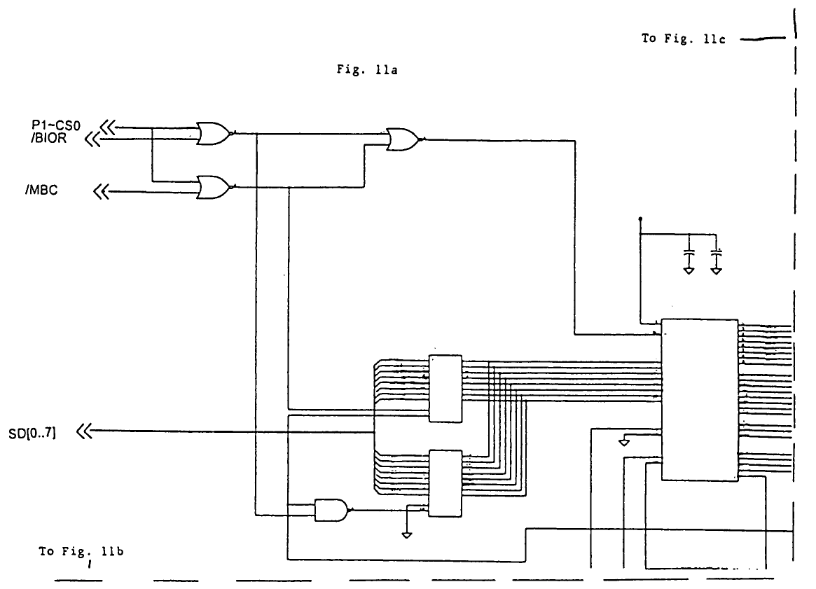

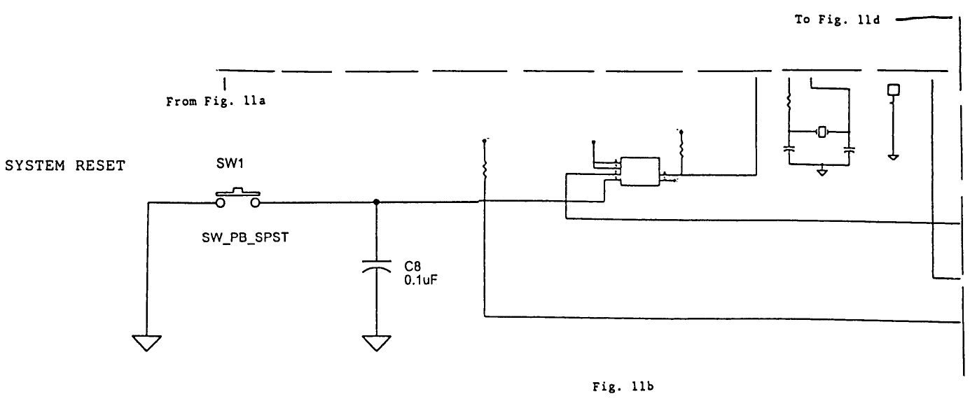

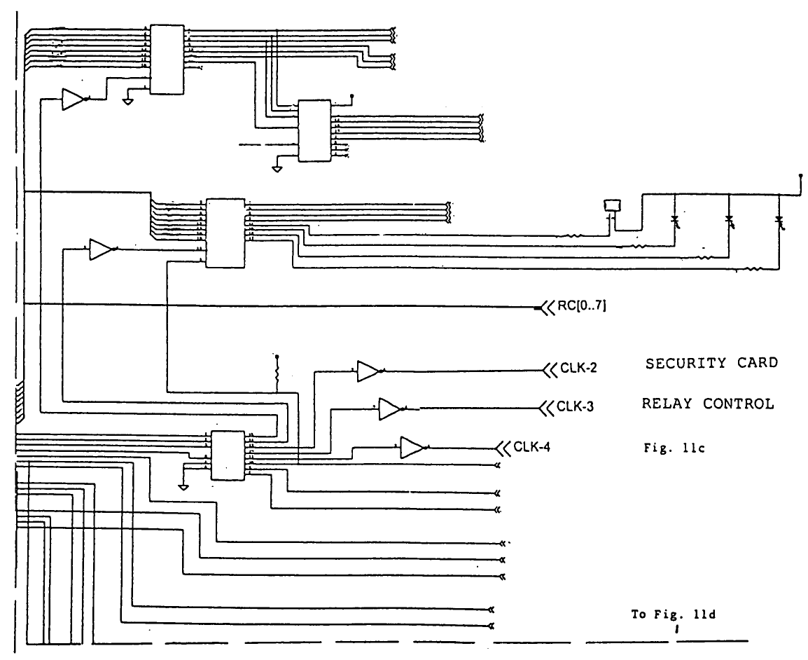

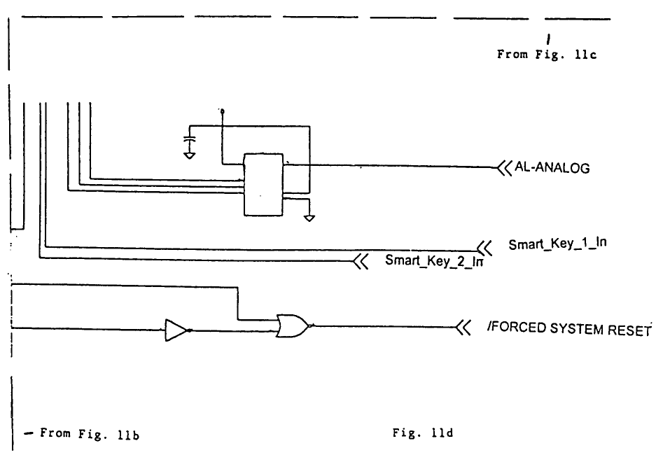

Referring to FIGS. 11a, 11b, 11c and 11d in combination, a schematic of the signal management processor circuit on the system platform is shown. System smart card 12 (FIG. 1) communicates with the circuitry of FIG. 11. Communication bus 84 from smart card 12 is seen in FIG. 11a. Embedded controller 86 is code-protected and provides the interface between smart card 12 and the system platform. Controller 86 provides information such as reporting the functioning of peripheral devices to smart card 12. Security zone inputs are shown generally at 88 of FIG. 11c. Controller outputs 90 are shown in FIGS. 11c and 11d.

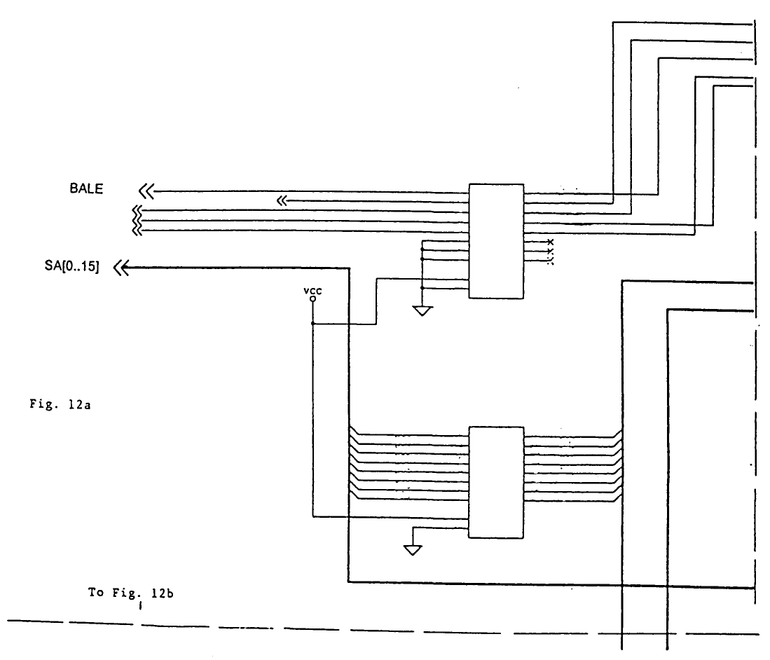

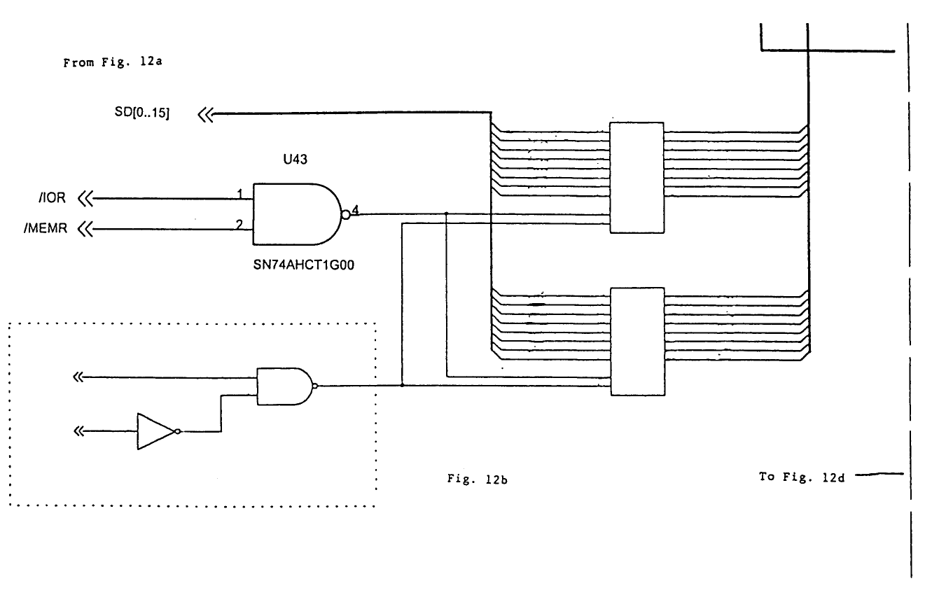

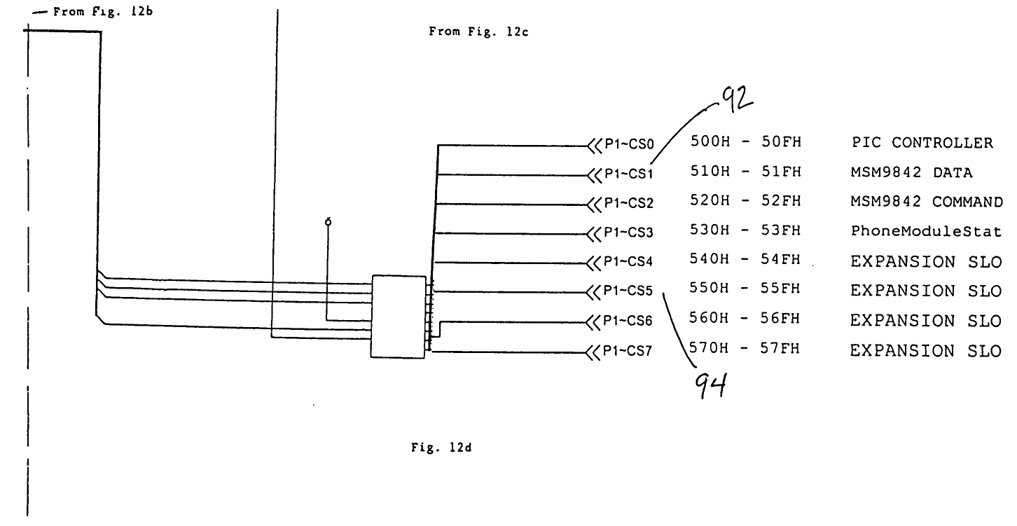

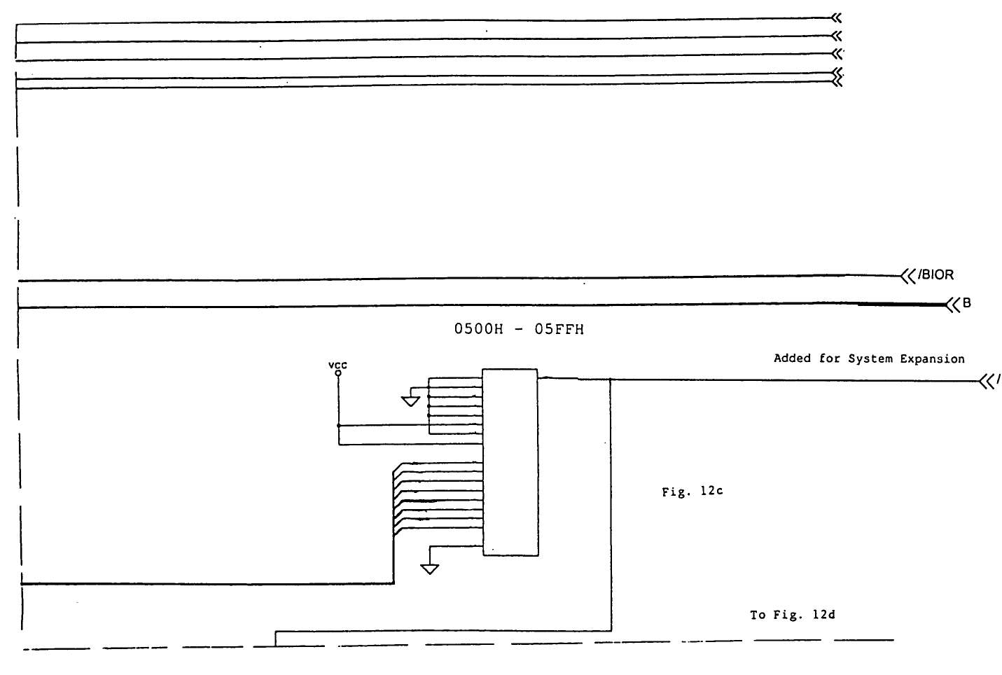

Referring to FIGS. 12a, 12b, 12c and 12d in combination, a second schematic of the signal management processor circuit on the system platform is shown. With particular reference to FIG. 12d, the “chip selects” 92 and 94 are shown. Expansion slot chip selects 94 allow chip select operation to occur on the system platform rather than on the corresponding expansion module.

III. System Interface

Most user-interface with system 10 occurs through a “smart” key placed into a key reader, or by operation of touchscreen 28. One or more key readers 64 communicate with the system platform to provide controlled access to the building. Each key reader 64 is independent of the other, allowing partitioned control of multiple sections of the building. Key readers 64 are adaptable to read input from numeric and/or alpha keypads.

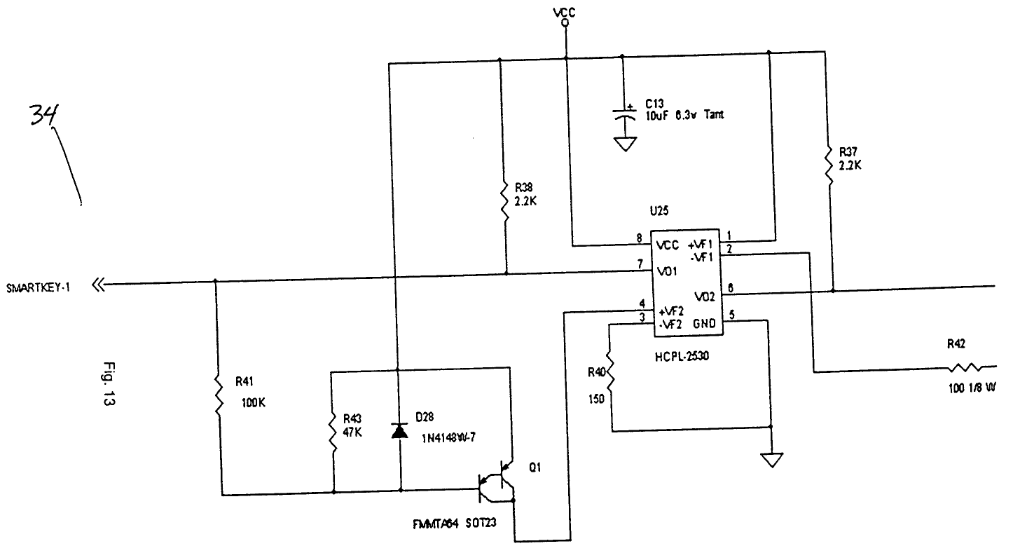

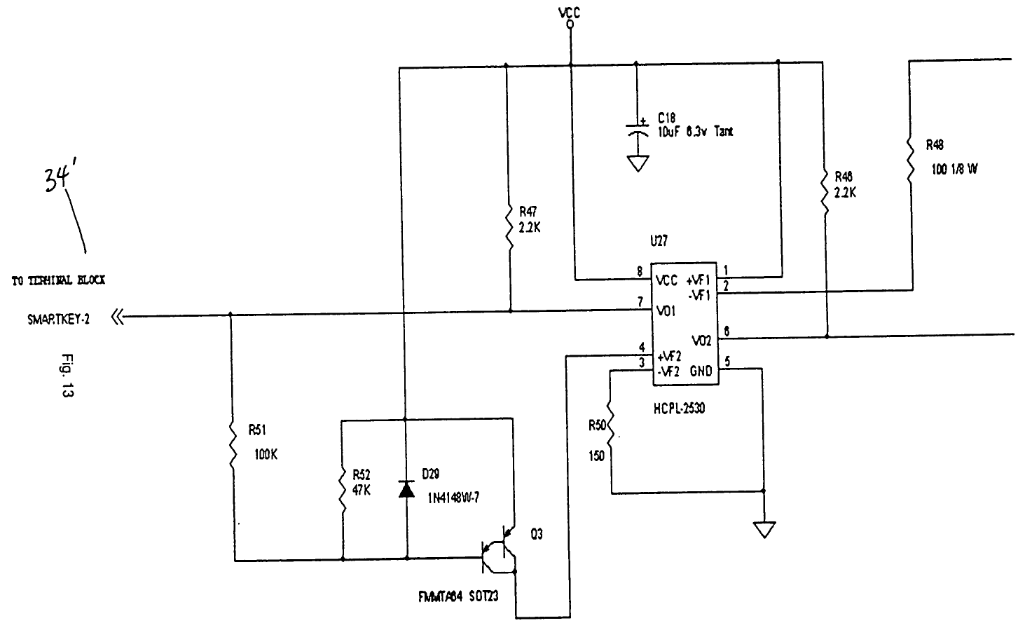

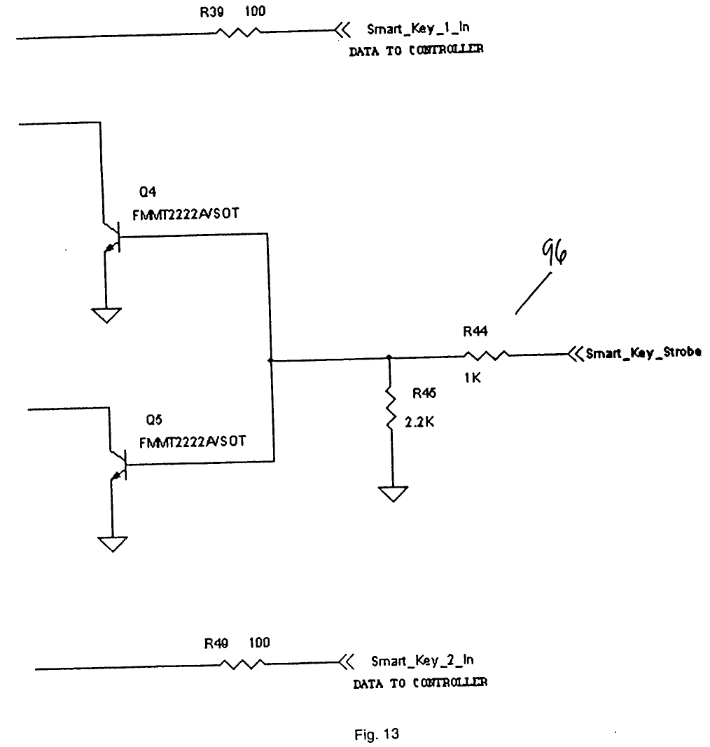

Referring to FIG. 13 a schematic of two “smart” key reader/drivers are shown. Strobe 96 is common to all key readers of the system. Strobe 96 sends a constant signal to the key readers to test whether a key is nested in the reader.

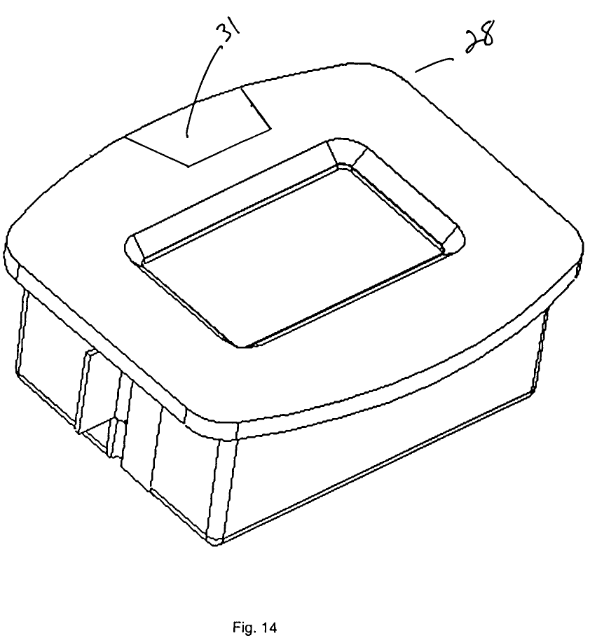

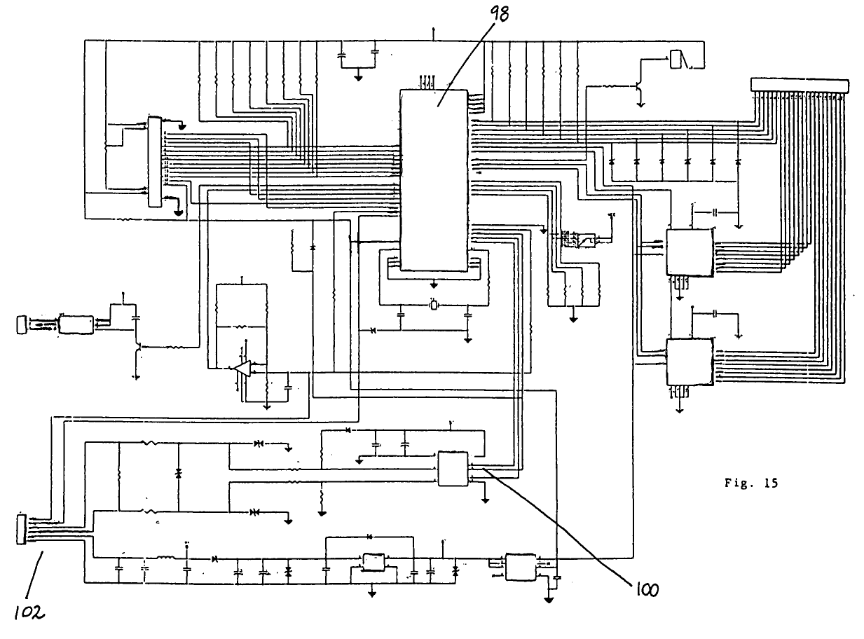

Referring to FIG. 14, a perspective view of a touchscreen 28 of the present invention is shown. Navigational icons are displayed on the touchscreen. An infrared window 31 is located at the top of the touchscreen bezel. FIG. 15 is a schematic of the touchscreen embedded controller circuit. Embedded controller 98 is in communication with the system “smart” bus, or RS 485 bus at 102. Voltage is changed from RS 485 differential mode to TTL logic at the circuit generally referred to at 100. Embedded controller 98 also monitors a thermistor that is on the face of touchscreen 28 for a reading of ambient temperature.

Referring to FIGS. 16a and 16b in combination, FIG. 16a shows a front view of key reader 64 and associated “smart” key 104, which in combination comprise the smart key access apparatus that operates in conjunction with system 10. Smart key 104 comprises communication button 106, such as the “i”™ button manufactured by Dallas Semiconductor, mounted into an assembly to be grasped by the user. In order to use key 104 to access system 10, communication button 106 of smart key 104 is nested into the mating nesting cradle 108 of key reader 64. Key ground 107 is electrically isolated from button 106 on key 104.

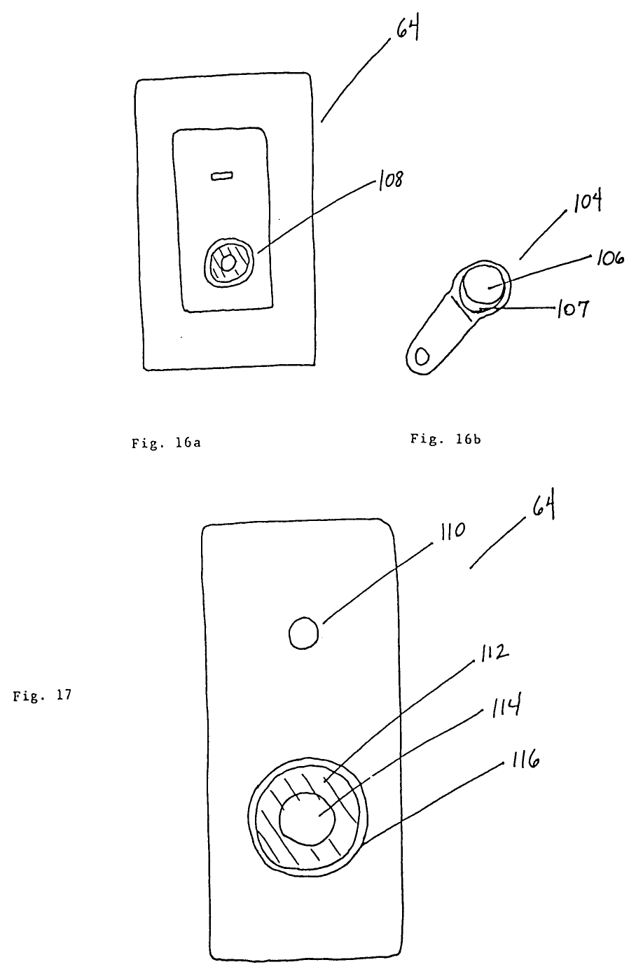

Referring to FIG. 17, the key reader assembly of key reader 64 is shown. System status LED 110 and cradle 108 are part of a face plate for key reader 64 that is mountable to a surface such as a wall. Cradle 108 is comprised of a center contact portion 114, insulating portion 112 and outer contact ring 116. When key 104 is nested into reader 64, a small voltage is applied across button 106 of key 104. Outer contact ring 116 provides ground contact while center contact portion 114 provides a power contact. Key reader 64 receives an encoded signal transmitted from communication button 106 when key 104 is nested in cradle 108 and makes contact with center contact 114 and outer contact 116 to receive voltage. It will be understood by those of skill in the art that the encoded signal transmitted from button 106 can comprise a variety of encoded signal types that will operate in accordance with the principles of the invention.

Each user of system 10 is assigned a smart key that transmits that user's encoded signal when nested in a key reader. Upon receiving the encoded signal, system 10 can set building control and automation parameters according to scenes, reactions, or macros programmed for that user.

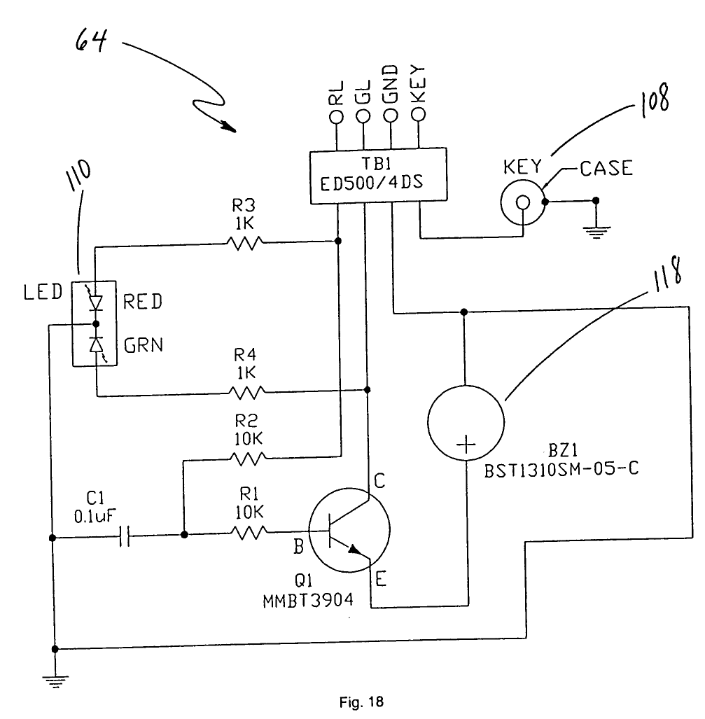

Referring to FIG. 18, a schematic of the circuitry of key reader 64 is shown. Nesting cradle 108 receives the transmitted signal from key 104. User-signaling device 118, such as a piezo-buzzer, is an audible signaling device used to alert the user. For example, signal device 118 may sound if the system is armed. LED 110 is a combined LED providing three possible visual alerts to the user, for example, red if the system is armed, green if unarmed, and yellow in the case of system inoperation. LED 110 blinks at a predetermined frequency to indicate a particular system inoperation, violated security zone, or other programmed event.

IV. System Cards and Modules

Telephone/modem/voice card 26 connects system 10 to a standard telephone line allowing the user to control all features of the system via voice-driven menus and keystrokes on any touchtone telephone inside or outside of the building. The voice drivers also deliver real-time information regarding the status of any system feature. The modem portion allows connection of a computer either locally or globally for the purpose of accessing system 10. The modem also contains an auto-dialer that seizes the telephone line and dials out to up to four independent user-programmed numbers in the event of an emergency.

Referring to FIG. 19, a first portion of a schematic of the telephone/modem/voice card 26 of the system is shown. Adaptive differential pulse modulated circuitry is indicated at 120. This circuitry produces audio, specifically artificial voice, information over the telephone operating in conjunction with system 10. System 10 allows storage of sound files in compressed memory, such as audible menu navigation instructions. Circuitry 120 reproduces the audio information to the telephone user.

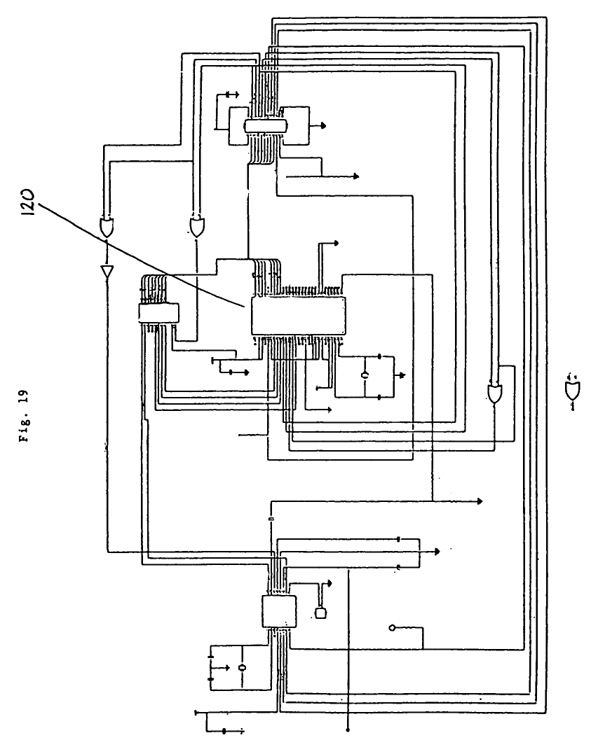

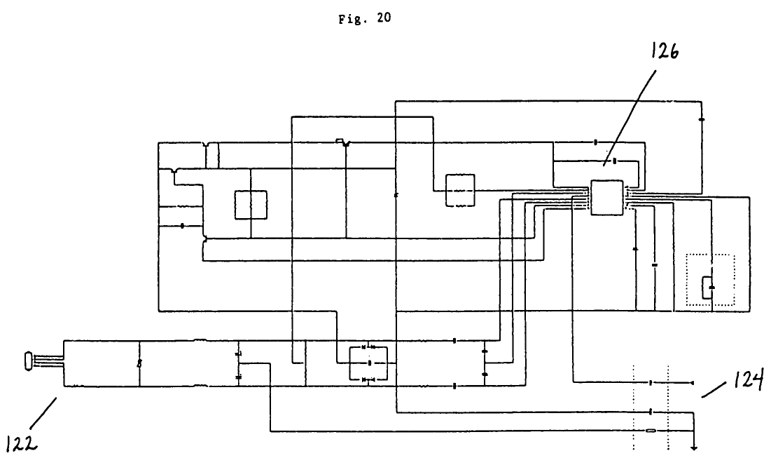

Referring to FIG. 20, a second portion of a schematic of the telephone/modem/voice card of the system is shown. FIG. 20 provides interface with telephone company wiring through a direct access arrangement. After passing through the circuitry of FIG. 3, the telephone signal from the telephone company interfaces with the circuitry at 122. High-voltage capacitors 124 are provided to ensure isolation of high voltages from incoming telephone signals, tip and ring, from system 10. Circuitry indicated at 126 provides interface with telephone signal protocols of a multitude of countries.

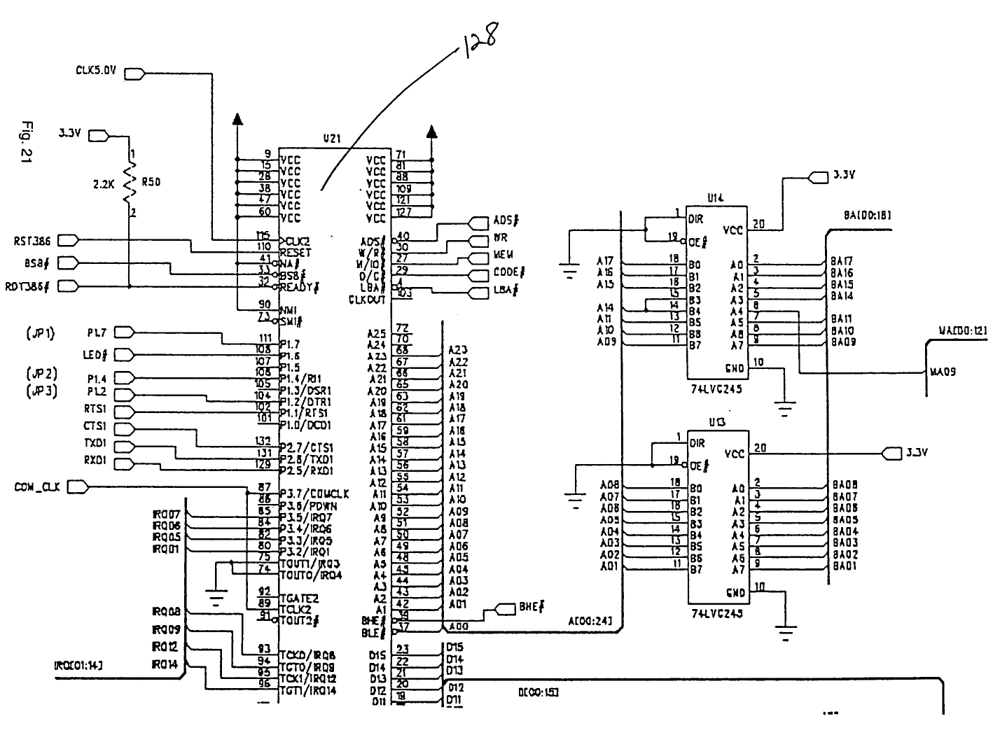

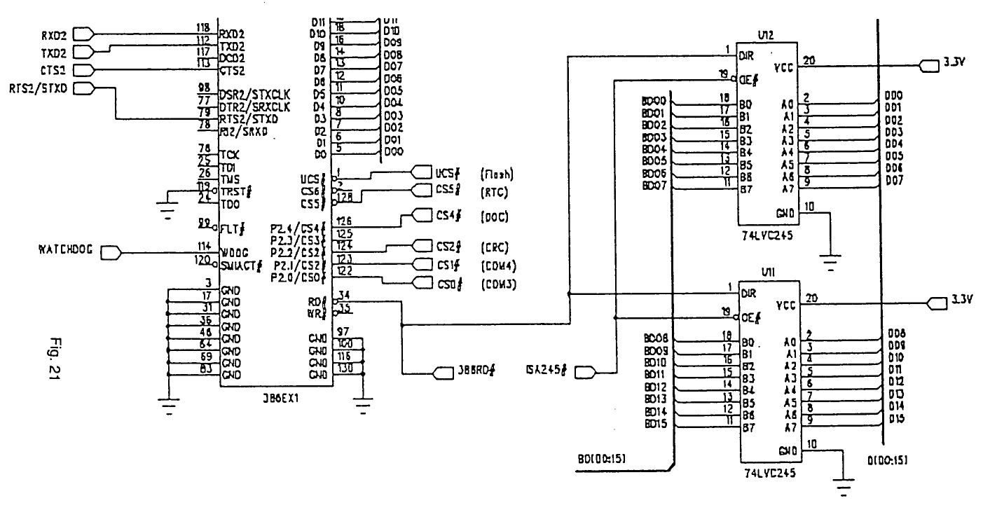

Referring to FIG. 21, a schematic of the microprocessor circuit of the system smart card 12 is shown. Controller 128 preferably comprises at least 33 MHz processing speed for efficient input/output control and control of expansion modules. An Intel 386ex processor operating in conjunction with a 16-bit external bus is one example of a processor appropriate for this task. Higher level processors are also suitable.

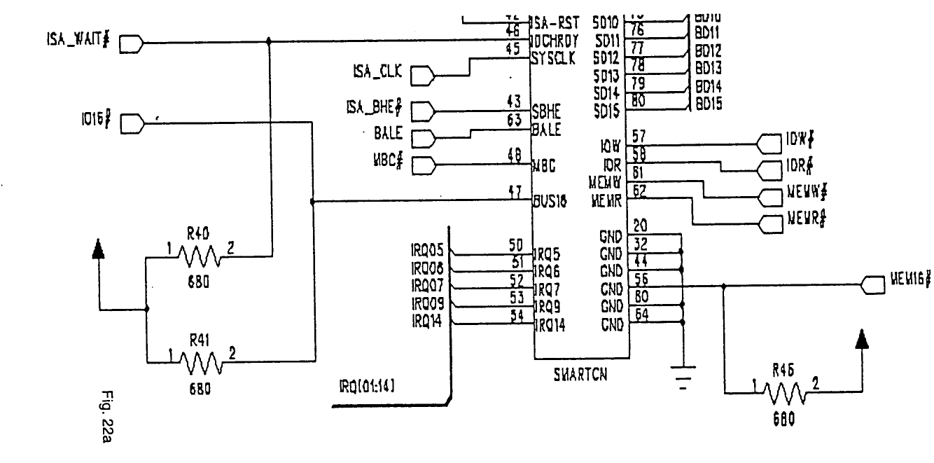

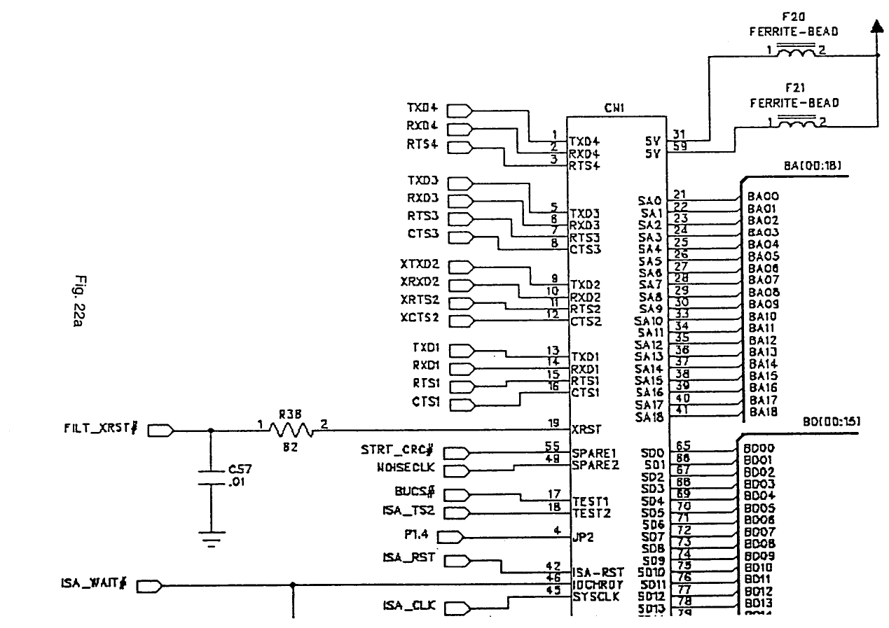

Referring to FIG. 22a, a schematic of the connector between smart card 12 and system platform is shown. FIG. 22b is a schematic of external flash memory for smart card 12. Preferably 4 megabytes of external memory are provided. FIG. 22c is a schematic of the real-time clock circuit for system 10. The clock circuit preferably contains a separate battery backup for confirmed operation.

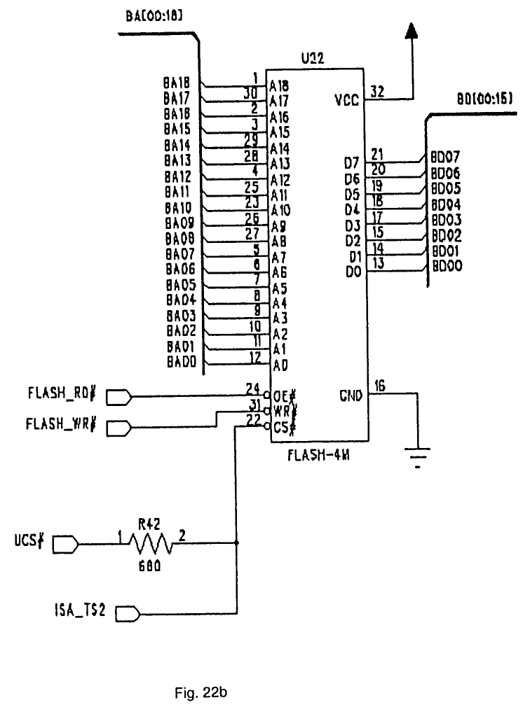

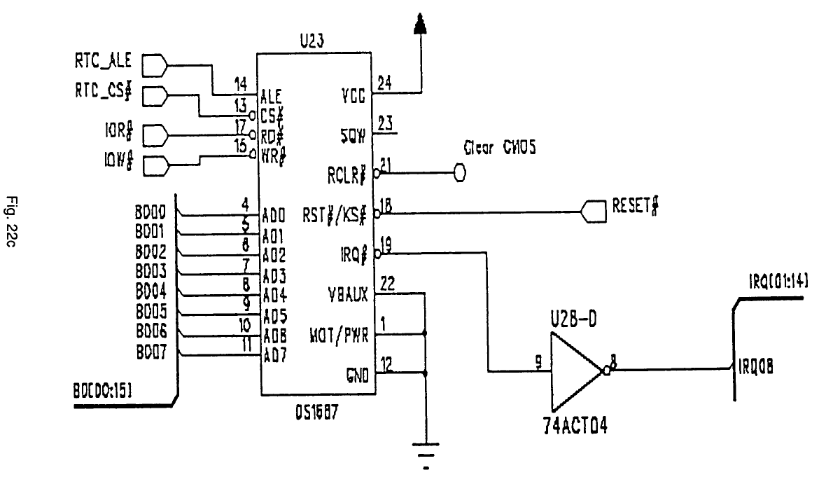

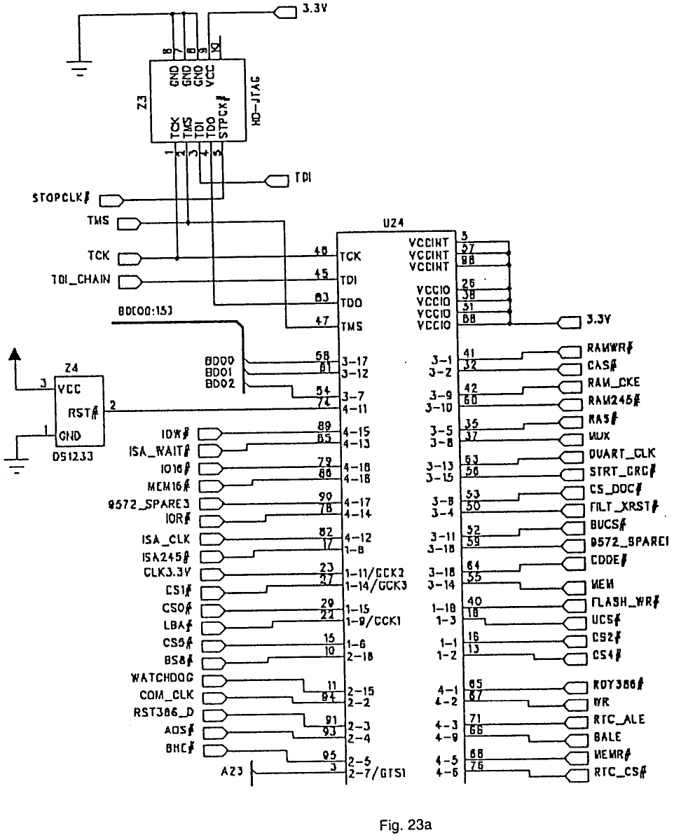

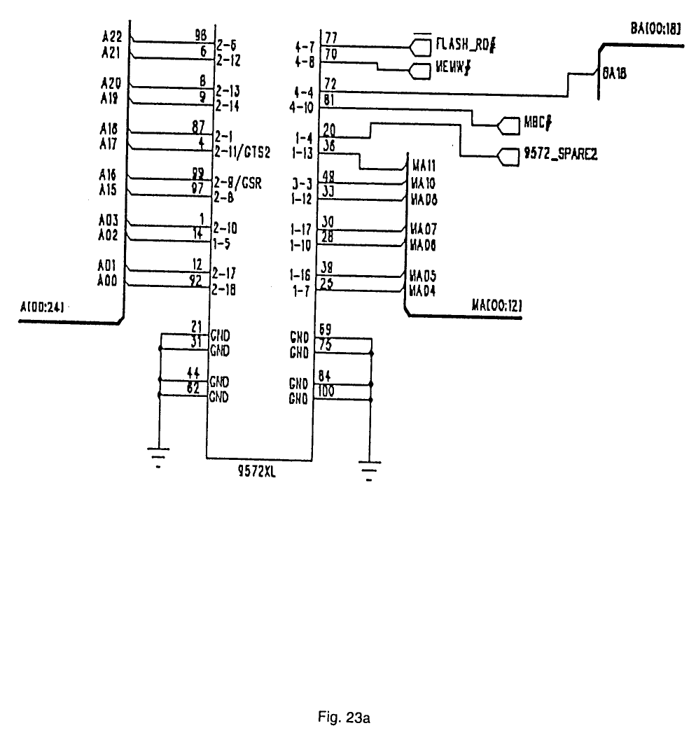

Referring to FIG. 23a, a schematic of a programmable logic device for smart card 12 for system operation is shown. FIG. 23b is a schematic of the signal bus controlling circuit for smart card 12. Bus drivers isolate the system processor from the bus.

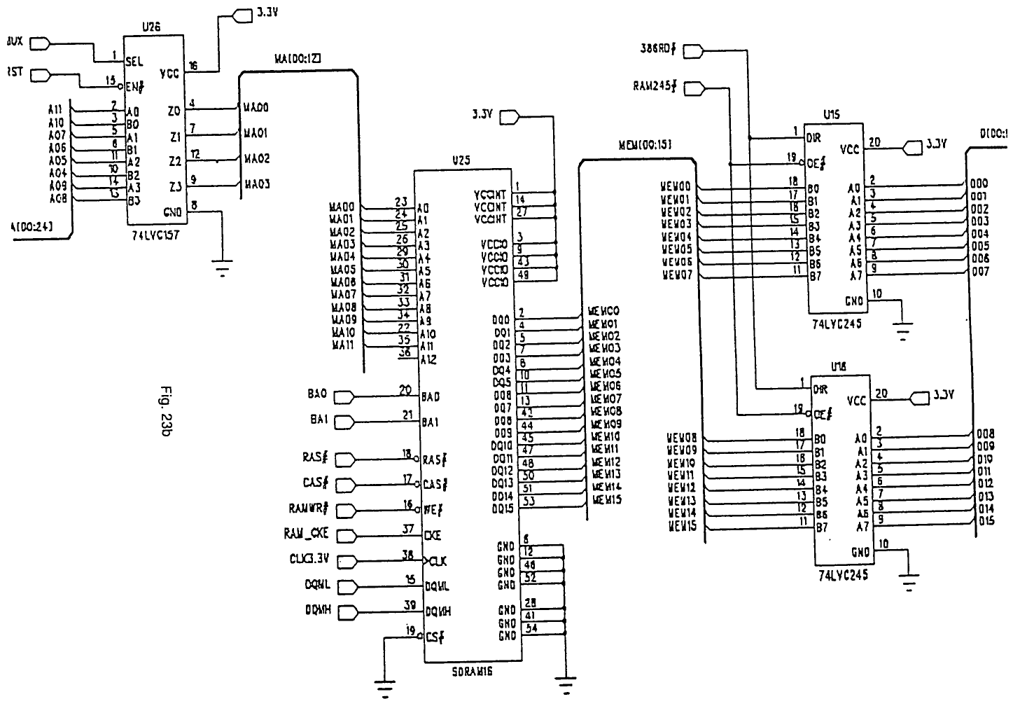

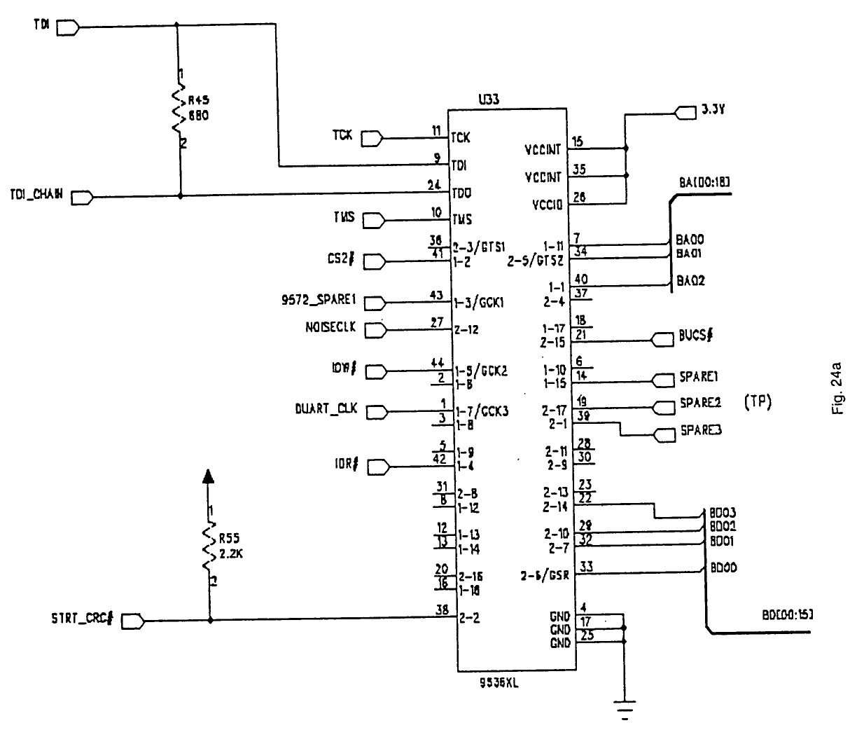

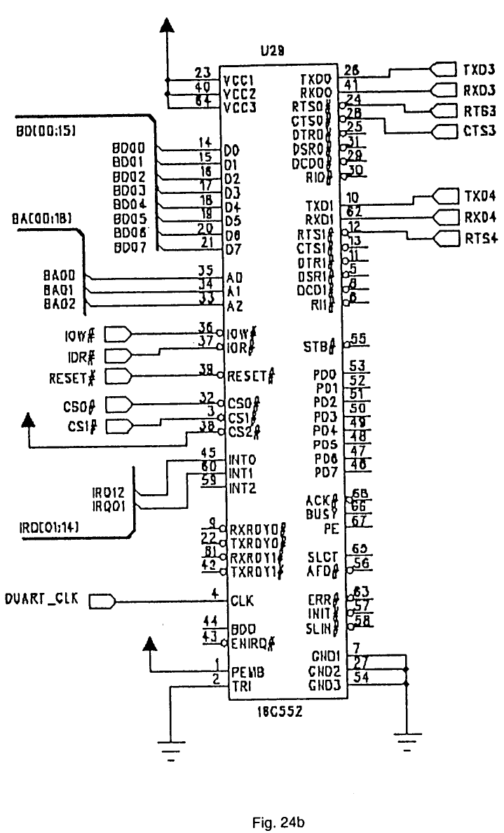

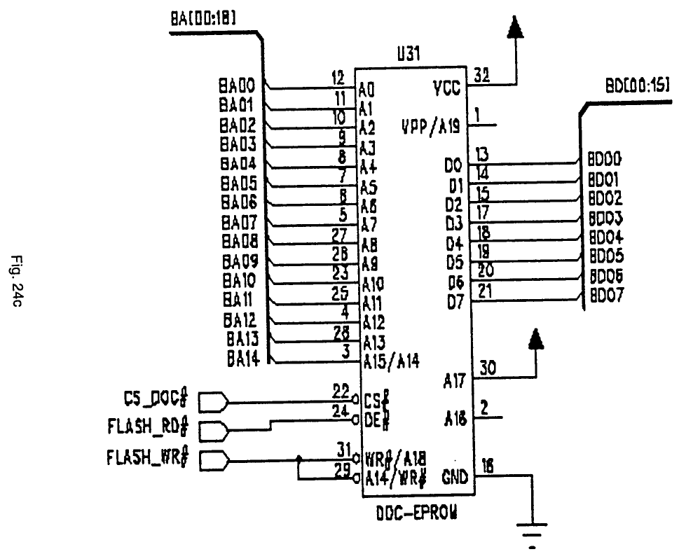

Referring to FIG. 24a, a schematic of a programmable logic device for cyclic redundancy checking between smart card 12 and the system platform is shown. FIG. 24b is a schematic of a dual asynchronous receiver transmitter that is used by system 10 to provide additional RS 232 ports. FIG. 24c is a schematic of a flash memory socket chip that serves as mass storage memory for system 10.

Referring to FIG. 25, a schematic of power supply card 24 is shown. Power supply card 24 provides power to the system platform, smart card 12, security card 22, telephone/modem/voice card 26, all expansion ports 20, as well as to a battery charger.

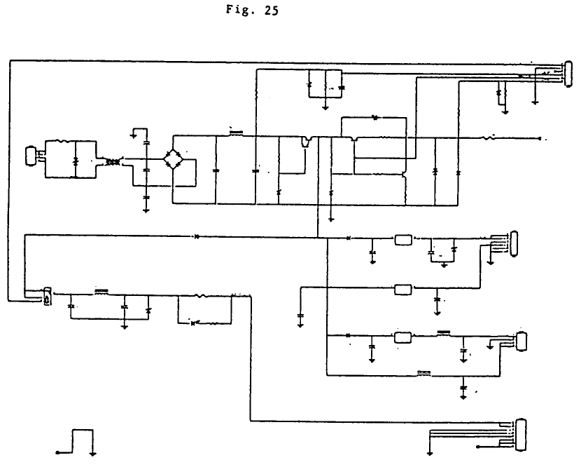

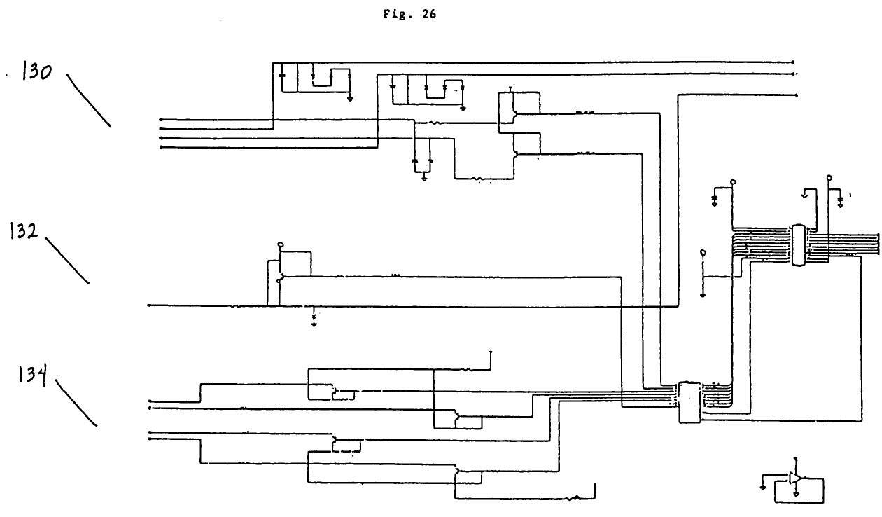

Referring to FIG. 26, a schematic of security card 22 is shown. Security card 22 provides the memory, input/output signal processing, and firmware the system requires for building security needs. One skilled in the art could of course include processing power to security card 22 as well. Preferably, a security card controls up to twenty security zones. Additional security cards can be added to system 10 by way of expansion ports 20 in order to provide control of additional security zones. Security card 22 comprises analog inputs 32, smoke or heat detector interface 54, and output to the siren or strobe 82. Communication with security devices can also be achieved through the system RS 232 and RS 485 interfaces, data bus via an expansion port and appropriate interface, as well as through infrared or rf transmission. Smoke detector interface 130, siren driver interface 132, and key reader LED driver interfaces 134 are controlled from security card 22.

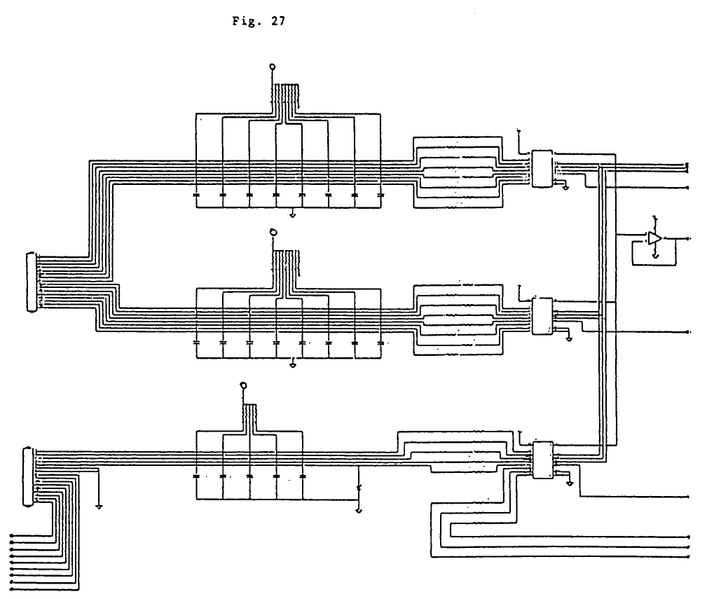

Referring to FIG. 27, a second portion of a schematic of security card 22 is shown. A multitude of main security loops connected between security card 22 of system 10 and a variety of sensing devices such as magnetic read switches, motion detectors, smoke detectors, gas detectors, glass breakage detectors, heat detectors, water leakage detectors, and other sensors, are shown in FIG. 27. These loops are preferably “supervised” loops, or “end-of-line” (EOL) loops so that opens and shorts are detected should they occur.

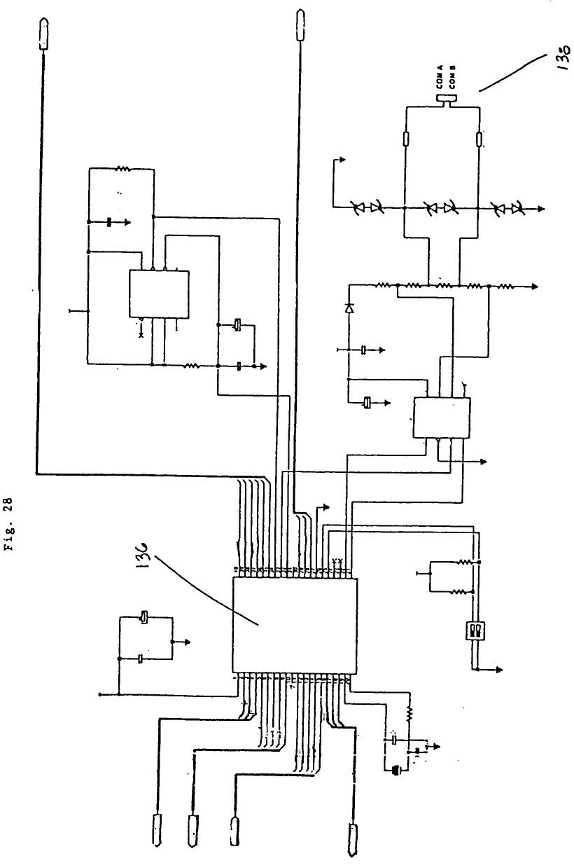

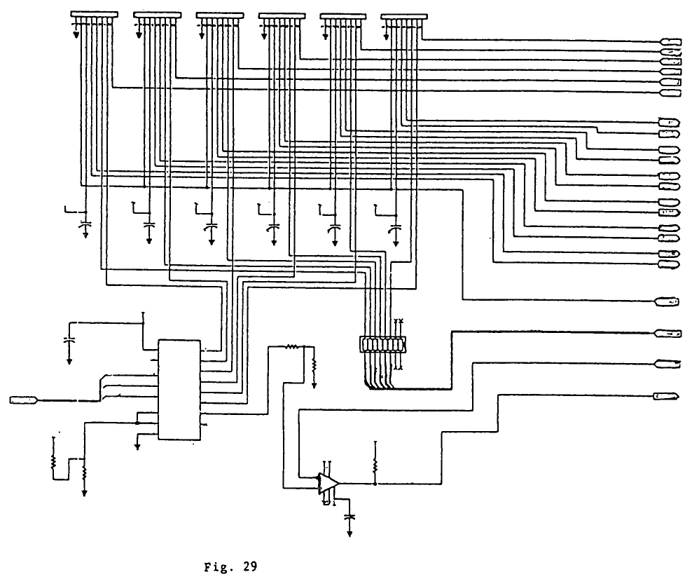

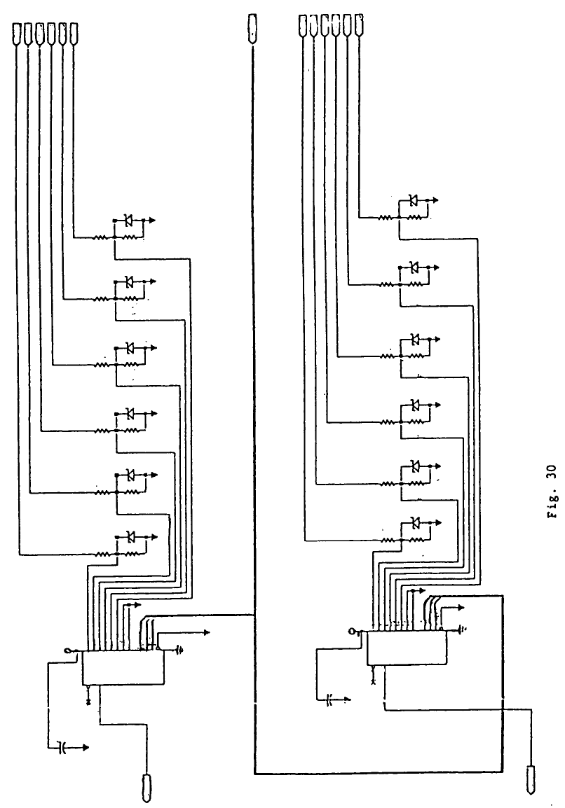

An audio expansion module is depicted in FIGS. 28-33. This module is external to the system platform and is used in conjunction with system 10 to provide interface and control of audio systems and distributed audio throughout the building. Referring to FIG. 28, a schematic of the audio expansion module embedded controller and RS 485 control circuit are shown. Embedded controller 136 communicates with the smart bus of system 10 at interface 138. Multiple audio zones, preferably up to 24 or more, can be controlled. FIG. 29 is a schematic of the audio expansion module input/output 8-channel digital to analog converter circuit. This circuitry provides control output to original equipment manufacturer (OEM) audio devices. FIG. 30 is a schematic of the audio expansion module source select circuitry. Inputs from OEM audio devices inform system 10 which audio source is currently selected.

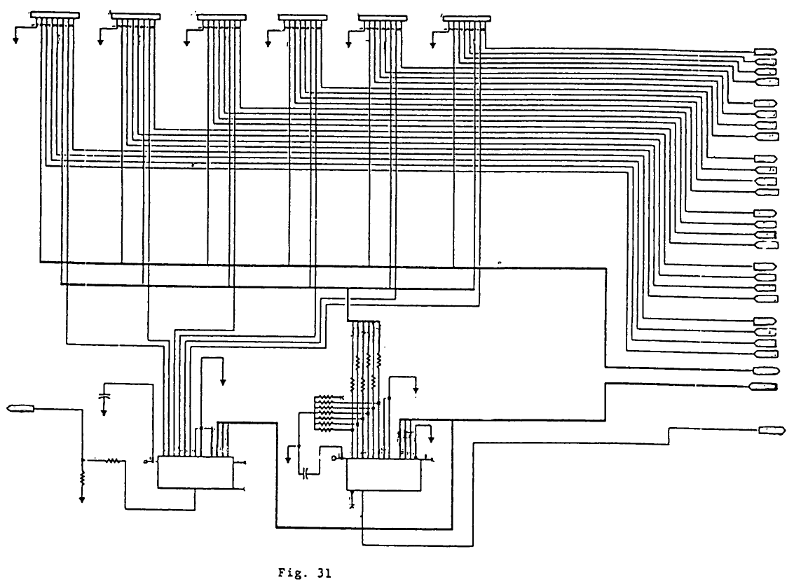

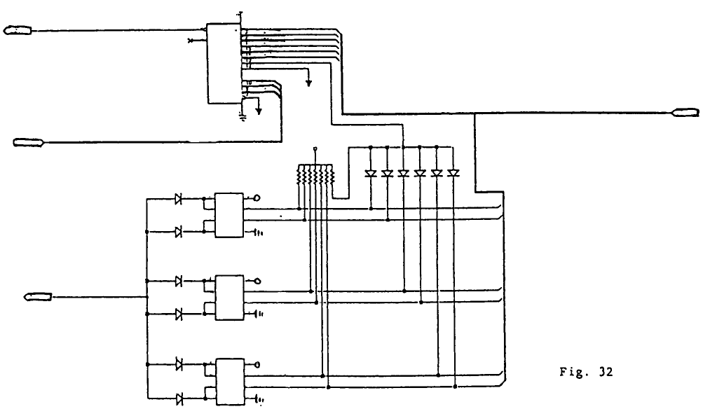

FIG. 31 is a schematic of the audio expansion module interface control circuitry which allows the user of system 10 to interface with the OEM audio device from either the OEM device control, such as a remote control, or from a system interface, such as touchscreen 28. Communication with the OEM device from the OEM control device is compatible with control by system 10. FIG. 32 is a schematic of the audio expansion module infrared signal decode and routing circuitry. System 10 intercepts infrared signals sent from OEM control devices, such as remote controls, and controls the audio device accordingly.

Referring to FIG. 33, a schematic of the audio expansion module interface buffer circuits and audio source status indicators are shown. This circuitry performs the function of selecting the audio source from an interface of system 10.

The Internet interface expansion module provides high-speed data interface and the system memory required to access the system via an Internet connection. This module allows system 10 to link directly to a predetermined website that contains specific, virtual, information pertaining to the building that contains the system. Once system 10 is linked to the appropriate website, the user has virtual control with three-dimensional representation of the building and interactive control of system features.

The PDA/Palm Pilot interface expansion module provides a wireless data interface and system memory required to access system 10 via a PDA or Palm wireless network. This module allows the system to link directly to a predetermined PDA address that contains specific information pertaining to the building that houses system 10. Once system 10 is linked to the appropriate address, the user has control with two-dimensional representation of the building and interactive control of system features. This module also provides the IRDA (infrared data association) infrared communication path to up/download data between system 10 and a PDA via an infrared window located at the top of the touchscreen bezel. Using the PDA stylus, the user can tap on areas of the PDA screen and adjust any aspect of the building operation while viewing virtual representation that reflects the adjustments.

The infrared/rf interface module provides wireless data interface and system memory required to access system 10 via a handheld remote control. This module allows system 10 to link directly to and from standard remote control devices that accompany audio/video devices. This module includes infrared and rf transmitters and receivers to upload/download data between system 10 and individual remote controls via the infrared window located at the top of the touchscreen bezel.

The expanded HVAC module adds control of additional HVAC zones to system 10 via additional relays. In addition to the relay control of HVAC devices, system 10 can be used to interface with HVAC devices via RS 232 and RS 485 protocols, data bus, or infrared and rf communication if the HVAC device is compatible with these protocols.

The energy management module provides wireless data interface and system memory required to connect and derive data from the electrical, gas, and water service meters associated with the building that houses system 10. System 10 receives the transmitted signals from the service meters via an energy management receiver module that receives and decodes the same wireless signal that is broadcast for the purpose of remote meter reading by utility companies.

A current transformer (CT) meter can be added to an energy meter in the event the utility company does not provide a wireless signal from the meter. Another energy management module interfaces between the CT meter and system 10 to derive data from electrical, gas, and water service meters associated with the building that houses system 10.

System 10 comprises an open architecture making it adaptable to expanded communication protocols or codes. A different expanded code module is available for adapting system 10 to each communication protocol, such as: consumer electronic (CE) bus, Echelon bus, Microsoft SCP, blue tooth IEEE standard, firewire IEEE standard, Leviton extended code, two-way X10, two-way A10, home plug industry bus, universal plug and play industry bus, home rf industry bus, and standard X10.

V. Touchscreen Operation

Touchscreen 28 functions as the primary user interface for the system allowing the user to set and change parameters of the system, as well as upload and download information to and from an infrared and rf receiver/transmitter located in touchscreen 28. Touchscreen 28 also acquires and represents system data to the user. System 10 can be operated by one or more touchscreens, preferably up to twelve touchscreens. Each touchscreen 28 includes an integrated thermostat, security keypad, scene keypad, audio/video remote control and keypad, family scheduler, multiple palm pilot or PDA synchronizer, individual email monitor, lighting control keypad, appliance control keypad, energy usage display, and message delivery system. Operation of the system touchscreen 28 is via a series of screen displays and navigational screens through which the user interfaces with the system. The touchscreen screens and icons set forth herein and set forth in U.S. Provisional Patent Application Ser. No. 60/339,511 entitled, “Building Automation and Control System”, filed on Oct. 22, 2001, are incorporated herein by reference. It will be understood by those of skill in the art that the following discussion of touchscreen operation to effect automation and control of building operation can be modified extensively and remain within the operating principles of the invention.

An initial global screen is used which the user encounters upon activation of touchscreen 28. The global screen reveals current date and time, current indoor temperature, current heating or cooling status, security status (e.g., where an open lock icon represents a disarmed security system and a closed lock icon represents an armed security system), and a “ready” indicator indicating that all zones of the building are closed and ready to arm. If the “ready” indicator is not present, the open zone names will be scrolled on the screen display. The current electrical energy consumption by the building is also displayed on the global screen by a number next to kWh (kilowatt hours). Outdoor temperature and weather condition, as reported by an auxiliary weather station device attached to the building, are also displayed. Sunrise and sunset times are displayed as determined by the latitude, longitude, and Greenwich Mean Time programmed into the system during system installation and configuration, resulting in a celestial clock for the system. In addition to displaying the status of security zones of the building, the global screen can additionally display messages to the user such as: “Good Morning! Touch for Control Menus,” or “Good Afternoon! Touch for Control Menus;” a reminder of the most recent scene executed; an indication of the zone status and listing of any open zones; a reminder of the most recent energy management related scene executed; company information; or current energy management status, such as “Current Energy Management Level: 1.”

After viewing the global screen, the user touches the screen to reveal a navigational menu screen for primary system features and functions. ‘Exit’ returns the user to the global screen. ‘Security’ takes the user to the security controls portion of the system. ‘Energy’ takes the user to the energy management controls portion of the system. ‘More’ is a navigational icon to reach more control icons. ‘Lighting’ takes the user to the lighting control portion of the system. ‘Outlets’ takes the user to the outlet control portion of the system. ‘HVAC’ takes the user to the heating and cooling controls portion of the system. ‘Scenes’ takes the user to the scene control and programming portion of the system.

If the ‘More’ icon is touched, the user is taken to a navigational menu screen for primary system features and functions. ‘Audio’ and ‘Relays’ icons take the user to other screens for control of these devices. ‘WWW’ takes the user to the world-wide web interface portion of the system. ‘Log’ takes the user to the telephone logbook of the system. The user accesses the user-programming portion of the system via the ‘Program’ icon. ‘Installer’ is used to access setup and configuration of the system.

a. Security Control

Upon pressing the ‘Security’ icon of the global screen, another screen appears, a basic navigation menu with icons relating to security functions for manipulating the security controls portion of the system. Typically, the user will select either ‘Stay’ or ‘Away’ to disarm or arm the system respectively. Upon pressing either of these icons, the system prompts the user for a code to arm/disarm the system.

For example, pressing ‘Stay’ and entering the proper code may arm the security sensors and detectors relating to the prevention of an intrusion designated as the perimeter of the building, disable the interior sensors and detectors relating to the prevention of an intrusion within the building, and assign a status to sensors and detectors related to smoke, gas, glass breakage, heat, water leakage and property protection unrelated to the selection of ‘Stay’.

Pressing the ‘Panic’ icon on the security screen results in an emergency dial-out screen display. Choosing an icon on the dial-out screen results in the system seizing the telephone line to automatically report an emergency to a fee-based central station monitoring service or to access a programmed telephone call list through the system automatic telephone dialer.

Pressing the ‘Bypass’ icon on the security screen produces a bypassed security zones screen. Any security zones presently bypassed by the system are listed on this screen. To add or delete security zones, the user presses the ‘Add’ or ‘Delete’ icons respectively. For example, the user may opt to bypass specific zones from being armed prior to arming the security portion of the system.

Pressing the ‘Chime’ icon on the security screen produces the security zones on a chime screen. Each zone on chime is listed on this screen. For example, the user may wish a common entry door not to chime when opened because of frequent use, but may wish a window to chime upon opening to announce an uncommon action.

Pressing the ‘Zones’ icon on the security screen produces a listing of the zones currently programmed into the security portion of the system. The ‘Log’ icon on the security screen is used to reach a security logbook screen. This screen provides a historical listing of security events of the system, including arming, disarming and alarms. A security event can be deleted from this list with ‘Delete’. ‘View’ is selected for additional data relating to a specific event. ‘OK’ returns the user to the prior screen. For example, a user may use the security logbook to review events such as: when and by whom the security system has been armed and disarmed, and which security zones were violated in the event of an intrusion and in what order.

b. Energy Management

Selecting the ‘Energy’ icon from the global screen produces a screen which provides the user the ability to select ‘Interactive Energy Management’ or ‘Energy Management Scenes.’ A scene is a particular set of events, for example arming a particular security zone and turning on certain lights, that are triggered to occur as a result of a particular trigger event and/or condition, for example time of the day and day of the week.

Interactive energy management is implemented by the installation of an additional module on the base system that relies upon consumption data from a compatible energy service meter owned by a utility provider, or an add-on CT meter. Energy management scenes are energy management macros for standard system features including electrical outlet, lighting and HVAC control. Energy management scenes do not require an additional module to be installed on the system, and are instead triggered normally through common system interfaces and scheduling.

Selecting the ‘Interactive Energy Management’ icon produces a smart energy management screen. The smart energy management screen is a navigational menu providing the user access to any of the following: ‘Meter’, which takes the user to the meter status information screen; ‘Triggers’, which takes the user to the screen where energy consumption peaks initiate energy management scenes; ‘Budget’, which takes the user to the energy management budget screen where monthly actual usage and budgeted usage are compared; ‘Cycle’, which takes the user to the status screen for the current energy management cycle; ‘Priorities’, which takes the user to a screen for programming the devices controlled during a particular energy management cycle; ‘Log’, which takes the user to the logbook for energy management events such as scheduled changes in energy management cycles, overrides and energy provider-triggered cycles; ‘Override’, which takes the user to the code-protected override screen for energy management cycles; and ‘Exit’, which returns the user to the global screen.

Selecting the ‘Status’ icon from the meter status screen takes the user to the energy management status screen. This screen provides a selection of devices that may be active and consuming energy. From this screen, the user determines which devices to add to smart energy management for a reduction in energy consumption.

An energy screen shows the user at what point the average hourly usage of energy triggers an energy management cycle. If the average hourly usage continues to increase, there are three programmed levels, EM1, EM2 and EM3 to reduce consumption automatically.

The current energy management cycle screen that shows the user the current energy management cycle for the present period as well as the next scheduled cycle change. From here, a screen is provided for the user to select from the specific devices programmed into each level of smart energy management where level 1 is the lowest and level 3 is the highest. Selection of ‘Level 1’ takes the user to a screen that enables the user to select which lights, devices and appliances are disabled during the Level 1 energy management cycle. Each cycle level is programmed in the same way; the only difference being the amount of lights, devices and appliances selected. Managed units are selected by pressing the circles adjacent the named device.

The energy management manual override screen warns users that are part of an energy management program sponsored by an energy provider that overriding the energy management cycles programmed into the system may result in penalties. Selecting ‘Override’ from this screen brings up a screen where the user must enter a code to proceed with manual override. Successful code entry brings the user to a screen where the user selects which lights, devices and appliances are returned to normal operation after an energy management cycle has been overridden.

Selecting the ‘Energy Management Scenes’ icon from the global energy screen produces a navigational menu screen for particular energy management scenes. The energy management scenes are additional to those scenes available through the general ‘Scenes’ icon of the global screen. Energy management scenes are energy management macros for standard system features including power outlet, lighting and HVAC control. For example, to modify ‘Energy Scene 0’, currently depicted as “empty”, the user selects ‘Modify’ then ‘Energy Scene 0’. This brings the user to a screen where the user can view the status of ‘Energy Scene 0’. From this screen, the user can ‘Add’ commands to the scene, which takes the user to the global screen in “record” mode. Selecting ‘Name’ takes the user to a screen where a custom designation can be typed in for this energy management scene. Selecting ‘Trigger’ takes the user to the standard scene trigger screen where the user can select the events to initiate that scene.

Upon selecting ‘Add’, the user is taken to the main navigational menu (global screen) in “record” mode. In this mode, the user selects which features to add to the energy scene. Selecting the ‘Lighting’ icon will display the controlled lighting icons as normal and allow the user to select which lights to add to the scene and the status to which they are set. For example, the user may choose a hall light that is controlled by the system to turn off (0%) as part of the scene. They may also select the ‘HVAC’ icon to setback a particular zone for heating or cooling. When finished, the user selects the ‘Energy’ icon to return to a screen to view the commands entered into the scene.

Upon selecting ‘Trigger’ the user is taken to the standard scene trigger screen where the user can select additional methods to initiate the scene. Scenes are always triggered by pressing the scene icon on the touchscreen, and can also be triggered by additional methods programmed from the trigger screen. Up/down arrows move the cursor (+) up and down to select a trigger that the user wishes to add. When the cursor is adjacent the desired trigger, the user presses ‘Edit’ to add or change triggers.

With continuing reference to the trigger screen, for example, a scene may be triggered by an incoming X-10 addressed signal such as a signal from an auxiliary control device. Preferably the system accommodates at least 256 X-10 addresses. Scenes, such as energy management and arming of security, may also be triggered by one or more smart keys, or, for example, by the last smart key input by the last user to exit the building. Scenes may also be triggered at a specific time of day. Scenes may be triggered by a specific security zone or group of zones; for example, the opening of a window may initiate a scene to deactivate all nearby controlled HVAC units to prevent energy loss. The initiation of triggers can be made conditional upon certain conditions, such as: armed, armed away, armed stay, disarmed, daytime, nighttime, weekend, weekday, and/or particular day of week. For example, a scene trigger may be a particular time of day, while the condition could be a certain day of the week, such as Friday, to make an office more energy efficient over the weekend.

Returning to the global screen in the “record” mode, selecting the ‘Lighting’ icon takes the user to the lighting control portion of the system. The lighting control screen is the standard navigational menu for viewing and manipulating the controlled lighting configured into the system. For lighting to be controlled by the system, the conventional light switch is replaced with a “smart” switch that communicates using a compatible PLC protocol. For example, the X-10 protocol can be used. Each light is labeled “Light #1”, “Light #2”, etc. up to the number of lights that the system can control, preferably as many as 200. The user can select the desired illumination via the power bar by touching at a particular location on the bar on the screen, or, for more precise control, by touching the (+) and (−) icons, after selecting the light to be configured. The amount of illumination is indicated next to the light currently being configured. Up/down arrows are used to move from one screen of lights to be configured to the next.

Selecting the ‘Outlets’ icon from the global screen while in the “record” mode takes the user to the outlet control portion of the system. The user can control the status of a particular power outlet by selecting the outlet, then choosing ‘On’ or ‘Off’ for that outlet. The system preferably controls up to 50 outlet loads. Up/down arrows are used to scroll from one screen of outlets to the next.

Selecting the ‘HVAC’ icon from the global screen while in the “record” mode takes the user to the HVAC controls portion of the system. The HVAC control screen displays which HVAC zone status is being viewed; HVAC zones are named at the time of installation of the system. The current temperature in that zone is displayed, as measured by a thermistor in the touchscreen. The fan symbol indicates the current operating status of the controlled HVAC system; for example, “COOL” indicates that the system is running the air conditioning to cool the controlled zone. High and low temperature set points are indicated at which the heating or cooling system will be activated. The high and low set points can be adjusted by the (−) and (+) icons to the immediate left and right. Selecting the ‘Fan’ icon from the HVAC control screen causes the HVAC fan to be set to operate in either on, off, or auto. Repeatedly pressing the ‘Fan’ icon causes it to cycle through the on, off and auto settings. Selecting the ‘Mode’ icon adjusts the operational mode of the controlled HVAC unit. Repeatedly pressing the ‘Mode’ icon cycles it through the options of cool, heat and auto. Repeatedly pressing the ‘Zone’ icon cycles it through the various controlled HVAC zones of the system.

c. General Scene Macros

Selecting the ‘Scenes’ icon from the global screen while in the “record” mode takes the user to the scenes control and programming portion of the system, which is different from the energy management scenes screen discussed above. The scenes control screen is the navigation menu for general scene macros, including security, power outlet, lighting and HVAC control. Scenes can be triggered normally through selection on the touchscreen or through triggers. To create or alter a scene, the user must select ‘Modify’ then the desired scene to be programmed, such as Scene 0. Upon selecting a scene to be programmed, the user is taken to a screen to program the scene. The screens encountered and the process of programming the scene is identical to that described above in programming an energy management scene and is not repeated here. Upon completion of adding commands to the scene, the user selects the ‘Scenes’ icon again from the global screen which takes the user back to a screen where the commands entered into that scene can be viewed.

In adding commands to the scene, the user can choose the ‘Audio’ icon after choosing the ‘More’ icon from the global screen while in the “record” mode. Choosing the ‘Audio’ icon takes the user to the audio controls portion of the system. The house icon of the audio control screen allows the user to select ‘All Zones’ for immediate control of all audio zones. The ‘Zone’ icon allows the user to select individual zones for control. ‘Source’ allows the user to toggle between the sources that are connected to the system. ‘Mute’ allows the user to mute/unmute the zone or zones that are being controlled. The music note icon functions as an on/off switch for the zone or zones being controlled; repeatedly pressing the music note icon removes/displays the volume bar and volume adjustment arrows. The “ALL ZONES” indicator indicates that all zones are presently being controlled in the same fashion and that any command performed will change all zones simultaneously. A “CD” indicator indicates that the present audio source is CD; repeatedly pressing ‘Source’ allows the user to toggle between the sources connected to the system, such as tuner, tape and auxiliary. Volume is adjustable in 1% increments by the single arrows and in 5% increments by the double arrows.

In adding commands to the scene, the user can choose the ‘Relays’ icon after choosing the ‘More’ icon from the global screen while in the “record” mode. Selecting the ‘Relays’ icon takes the user to the relays control screen. Relays are contact closure connectors employed for control of non-system peripherals such as automated windows and pool coverings, retractable home theater screens and sprinklers. The user selects the relay to program, sets it to ‘On’ or ‘Off’, then selects the next relay to program. The arrow icons allow the user to scroll from one screen of relays to the next. Preferably, up to four relays can be controlled from the system platform. Additional relay control can be added through expansion cards to the system platform.

In adding commands to the scene, the user can choose the ‘WWW’ icon after choosing the ‘More’ icon from the global screen while in the “record” mode. Selecting the ‘WWW’ icon takes the user to the Internet interface screen. Customized Internet content is delivered to the system and presented to the user through this screen. The system is connected to the system provider's central server for downloading on a preset schedule.

In adding commands to the scene, the user can choose the ‘Log’ icon after choosing the ‘More’ icon from the global screen while in the “record” mode. Selecting the ‘Log’ icon takes the user to the smart telephone system logbook screen. The smart telephone system logbook logs every call made in response to an event. Up/down arrows are used to scroll through the logged calls.

d. User-Programming of the System

From the scenes control screen, the user can choose the ‘Program’ icon after choosing the ‘More’ icon from the global screen while in the “record” mode. Selecting the ‘Program’ icon takes the user to a code-entry screen where entry of the proper code allows access to the user-programming portion of the system. Successful code entry takes the user to the primary navigational screen for system configuration by the user. This screen includes: ‘Setup’ which allows the user to configure the system setup parameters; ‘Schedules’ which allows the user to set feature schedules; ‘Options’ which allows the user to select and configure system options; and ‘Support’ which allows the user to allow remote access to the system through the telephone line and ATLAS software (described below).

Selecting ‘Setup’ takes the user to the primary navigational screen for system configuration by the user. Selecting the date and time icon brings the user to a screen that allows the user to input date and time information with the up/down arrows. The ‘Clear’ icon clears the current data displayed and the ‘Cancel’ icon cancels changes made by the user.

Selecting the deterrents icon from the system configuration screen takes the user to a screen where the user selects which controlled lights to react in a random pattern during the evening and an “away” security status. Selecting the temperature programming icon takes the user to a screen where the user can change the zone names and establish a default set point for each zone. Selecting the telephone programming icon takes the user to a screen where the user can configure the system auto-dialer call list. This screen is the main navigational menu for the user to configure the telephone-based features of the system.

Selecting ‘Options’ from the telephone configuration screen takes the user to a screen which allows the user to configure the dial-in features of the system. ‘Rings Before Answering’ is the number of rings that the system will pass before it seizes the line and prompts the caller to enter an access code. Toggling the adjacent ‘Edit’ icon cycles the number of rings from 1 through 9, or other number of rings as programmed into the overall functioning of the system. ‘Answering Machine’ can be toggled either yes or no with the adjacent ‘Edit’ icon. ‘Detect Dial Tone’ is an automatic system feature that can be toggled either yes or no with the adjacent ‘Edit’ icon.

Selecting ‘Local Number’ from the telephone configuration screen takes the user to a screen which allows the user to program the identification number that the system announces when it auto-dials its call list. To enter the identification number, the user selects the ‘Number’ icon which takes the user to a screen where the user enters up to a twelve-digit number. The user selects one of the building types listed on the screen to indicate the type of building in which the system resides.

Selecting ‘Emergency’ from the telephone configuration system takes the user to a screen where the user can enter/edit telephone numbers on the auto-dial list for various emergency services. Selecting ‘Contacts’ takes the user to a screen that allows the user to select up to four, or more depending upon the configuration of the system, contacts for the system to dial directly and announce the nature of an emergency. To edit a contact, the user selects the ‘Edit’ icon which takes the user to a screen that allows the user to enter the contact's name and to choose the type of alert in which the contact will be called. The default setting is “contact 0”. Selecting the ‘Name’ icon will take the user to an alphanumeric keypad to enter the name of the contact person or service. A box of the screen is filled by selecting the ‘Number’ icon and entering the telephone number of the contact person or service. A horizontal listing of services in the middle of the screen allows the user to select the nature of the emergency of which the contact is notified. One or all announcements can be selected.

Selection of the music note ‘Prog’ icon from the system configuration screen takes the user to the audio configuration screen. Selection of ‘Audio Zones’ from this screen takes the user to a screen which allows the user to scroll between each audio zone with the arrow icons. Selecting ‘Edit Description’ takes the user to a screen where the description of that audio zone can be edited. Selection of ‘Audio Sources’ takes the user to a screen where the user can scroll between the audio sources with arrow icons. The description of the audio source can be edited by selection of the ‘Edit Description’ icon which takes the user to an alphanumeric keypad for data entry.

Selection of the ‘kwh Prog’ icon from the system configuration screen takes the user to a screen where the user can view real-time energy consumption information.

Selection of the security ‘Prog’ icon from the system configuration screen takes the user to the main navigational screen for configuration of security parameters. Selecting the ‘Codes’ icon from this screen takes the user to a screen that lists the names of users programmed into the system. Selecting the ‘Add’ icon allows the user to add users to the system and to program the type of access code and the code itself for the user. The ‘Name’ icon is selected to enter a name for the code via an alphanumeric keypad screen. Selecting the ‘Code’ icon takes the user to a code-entry screen to enter the code. After the name and code are entered, the user selects the level of access for that particular code. ‘Security Access’ allows normal operation of the security system. ‘Master Access’ allows access to all areas of user programming and energy management overrides. ‘Easy Exit’ may allow security arming only, so that the user does not have full-time access. ‘Hostage’ activates a silent alarm in the event that it is entered. These types of access are only examples that are programmable into the system of the present invention. The invention is not limited to any particular types of access. Selection of the ‘Edit’ icon allows the user to modify existing user codes. Codes are deleted with the ‘Delete’ icon.

Selection of the ‘Delay’ icon from the security configuration screen takes the user to a screen which allows the user to configure the length of the delay time for each entry/exit zone and the amount of time that the siren will sound during an alarm before shutting off. The ‘Edit’ icons adjacent each parameter are used to edit the delay and/or cutoff times.

Selection of the ‘Panic’ icon from the security configuration screen takes the user to a screen that allows the user to declare whether the system will respond to each panic setting and whether or not the siren will sound during this alarm.

Selection of the ‘Keys’ icon from the security configuration screen takes the user to a screen which lists the names of the “smart” key users programmed into the system. “Smart” key users can be added, existing names edited, or deleted from this list by selection of the appropriate icons. Selection of the ‘Add’ icon takes the user to the main navigational screen for “smart” key configuration. At this screen, the ‘Valid’ icon toggles the user's ability to use this particular key, such as: always, days only, nights only, weekends only, weekdays only, or certain days of the week. ‘Expires’ takes the user to a screen where the time, month, date and year can be entered at which time the key will be removed from the system. ‘Name’ allows the user to enter the name of the key user on an alphanumeric keypad screen. ‘Read’ prompts the user to place the key onto a key reader to “read” the key into the system.

Selection of the ‘Test’ icon from the security configuration screen sounds an alarm for a preset number of seconds to test the system functionality on a routine basis.

Selection of the ‘Schedules’ icon from the system configuration screen takes the user to the primary navigational screen for programming scheduled features, which allows the user to program security scheduling, lighting scheduling, temperature scheduling, outlet scheduling, audio scheduling, energy management cycle scheduling, and reminders.

Selection of the security scheduling icon takes the user to a screen which lists the present security scheduling events programmed into the system. Selecting ‘Add’ from this screen allows the user to add a scheduled security event. The user can specify the day of week and the time of day for security schedules. The user can select the security icon which takes the user to a screen to select the scheduled security level. Selection of the ‘Time’ icon takes the user to a screen to choose the time that the security schedule is initiated. For example, a user may select the security system to be armed in the “stay” mode every night by 11 pm. Up/down arrow icons allow the user to scroll through multiple security schedules.

Selection of the lighting scheduling icon from the scheduling screen takes the user to a screen that lists the lighting scheduling events programmed into the system. From this screen the user may add, edit existing events, or delete events from the system. Selection of the ‘Add’ icon takes the user to a screen where the user selects the day of the week, then selects the light bulb icon which takes the user to a screen to select the scheduled lighting level. The user selects the ‘Time’ icon which takes the user to a screen to select the time for the lighting schedule to be initiated. The up/down arrow icons allow the user to scroll through multiple lighting schedules.

Selection of the temperature scheduling icon from the scheduling screen takes the user to a screen that lists the HVAC scheduling events programmed into the system. The procedure for programming an HVAC scheduling event parallels that for scheduling a security or lighting event discussed above. For example, the user may schedule HVAC zone #1 to have an “auto” mode of operation as well as an “auto” mode of operation for the fan, and a temperature range of 66 to 73 degrees on Monday and Tuesday at 4 pm.

Selection of the outlet scheduling icon from the scheduling screen takes the user to a screen that lists the outlet scheduling events programmed into the system. The procedure for programming an outlet scheduling event parallels that for scheduling a security or lighting event discussed above.

Selection of the audio scheduling icon from the scheduling screen takes the user to a screen that lists the audio scheduling events programmed into the system. The procedure for programming an audio scheduling event largely parallels that for scheduling a security or lighting event discussed above. For example, the user may schedule audio zone #1 with the CD as the source, a volume of 20%, to activate on Friday at 6 pm. As in all scheduling events, selecting the ‘OK’ icon brings up a screen which lists the audio scheduling event on the audio schedule screen.

Selection of the energy management scheduling icon from the scheduling screen allows the user to configure scheduled energy management cycles turning on and off. In an installation where an energy provider is connected to the system a part of a utility-sponsored energy management program, energy management cycles are scheduled to take advantage of different pricing structures during different parts of the day. For example, afternoon and early evening rates are the most expensive, while the middle of the night is least expensive. The procedure for programming energy management scheduling parallels that for scheduling a security or lighting event discussed above. The user is taken through screens to program energy cycles.

Selection of the reminders icon from the scheduling screen allows the user to configure and schedule tasks and reminders. Upon selecting the reminders icon, the user is taken to a screen that lists the reminders presently programmed into the system. The procedure for programming reminders into the system parallels that for scheduling events. For example, a reminder can be programmed into the system with the message to “take trash out” on Thursday at 9 pm.

Returning to the system configuration screen, selection of the ‘Options’ icon takes the user to a screen that lists the available options that the user may adjust relating to system performance. For example, the system may have been programmed to beep each time the touchscreen is pressed. Selection of the ‘Support’ icon from the system configuration screen takes the user to the main navigational screen for technical support of the system. Selection of the ‘ATLAS’ icon from this screen takes the user to a screen where an installer can remotely access the system through ATLAS software. A screen allows the user to enter an access code that allows an installer to remotely dial in to the system to perform programming changes and system diagnostics. Selection of the ‘Contact info’ icon provides general contact information for the installer, including telephone numbers and technical support help lines.

e. Installer Programming of Basic System Operation

Returning to the global screen, selection of the ‘Installer’ icon prompts the user, in this case the installer, to enter the installer code on a numeric keypad screen. Upon entry of the correct code, the primary navigational screen for the installer to configure basic system operation is displayed. Selection of the ‘Status’ icon takes the installer to a screen that lists the current version of the system software and current system hardware. Touching this screen anywhere returns the installer to the previous screen.

Selection of the ‘Touchscreens’ icon from the installer configuration screen takes the installer to the navigational screen for configuring each system touchscreen. The primary touchscreen for the system is referred to as the “global” touchscreen. Selection of the ‘Touchscreen‘ icon from this next screen takes the installer to a screen where the installer toggles through each touchscreen connected to the system. The designation for each touchscreen displays to the right. Additional information about the touchscreen is also displayed. Additional information is entered by the installer after selecting the ‘Description’ icon. Selecting the ‘Description’ icon brings up an alphanumeric keypad screen where the installer can enter the additional information to be displayed about that particular touchscreen, such as location and functional information.

Selection of the ‘Security’ icon from the installer configuration screen takes the installer to a screen which lists the security zones entered into the system. From this screen the installer can add, edit existing security zones, or delete security zones from the system. Selecting the ‘Add’ icon takes the installer to the main programming screen for adding security zones. Selection of the ‘Name’ icon allows the installer to enter the name of the security zone via an alphanumeric keypad screen. Repeatedly pressing the ‘Type’ icon cycles the installer through choices of types of security zones for the zone: delay 1, delay 2, instant, follower, interior, tamper, fire, medical, police and inactive. Repeatedly pressing the ‘Mode’ icon cycles the installer through choices of modes for the security zone: open, closed or end-of-line (EOL). Repeatedly pressing the ‘Bypassable’ icon toggles the installer through choices of whether the user may bypass the security zone: yes or no. Repeatedly pressing the ‘Attributes’ icon cycles the installer through choices of attributes for the security zone: door, window, motion, glass, gas, water, freeze and heat.

Returning to the installer configuration screen, selection of the ‘Energy’ icon allows the installer to configure the interactive energy management hardware connected to the system. The interactive energy management module, installed by the installer, includes a transceiver that receives the information broadcast through rf technology from a “smart” energy meter, similar to the operation of a conventional cordless telephone. Each interactive energy management module has a programmable serial number to receive the proper signal form the energy meter.

Selection of the ‘Lighting’ icon from the installer configuration screen takes the installer to a screen where the installer can configure controlled lights for the end user. Selection of the light #1 icon takes the installer to the navigational screen for configuring that particular light.

Selection of the ‘Name’ icon from the light configuration screen allows the installer to enter a custom name for the particular light to be controlled via an alphanumeric keypad screen. Selection of the ‘Type’ icon toggles the installer to the current communication protocol for the light. Selection of the ‘Event Reactions’ icon takes the installer to a screen that displays the event reaction choices available to the installer to which the light will react. Pressing any of the icons on this screen toggles the event reaction between yes and no. Selection of the ‘Zone Reactions’ icon from the light configuration screen takes the installer to a screen where the installer can configure the reaction of the controlled light to security zones. Arrow key icons are used to scroll through the programmed security zones. The installer may customize the reaction of the controlled light by establishing a time frame, ‘From’ and ‘To’, in which it will respond, the illumination value at which it will respond, and the duration of time that it will remain illuminated after responding. Selection of the ‘Deterrents’ icon from the light configuration screen allows the installer to configure the activation of the controlled light during a deterrent event. Selection of the ‘Deterrents’ icon takes the installer to a screen where the installer toggles through the number of minutes for which the light will be on during a deterrent event. Adjacent the ‘X-10’ icon of the light configuration screen, the current communication protocol for the controlled light is displayed. Selecting the ‘X-10’ icon takes the installer to a screen that allows the installer to code the controlled light to the proper PLC address. There are preferably 256 possible X-10 addresses. Selection of the ‘Max Bright’ icon takes the installer to a screen where the installer can set the maximum illumination value of the controlled light, for example 90%, for energy management purposes.

Returning to the installer configuration screen, selection of the ‘Outlets’ icon takes the installer to a screen where the installer can select which outlet to configure. Selection of a particular outlet to configure takes the installer to the outlet configuration screen.

On this screen, the ‘Name’ icon displays the name for this particular outlet. Pressing the ‘Name’ icon allows the installer to enter a custom name for the outlet through an alphanumeric keypad screen. Selecting the ‘Event Reactions’ icon takes the installer to a screen which displays the event reaction choices available to the installer, to which the controlled outlet will react. Pressing any of these choices toggles them between yes and no. Selecting the ‘Zone Reactions’ icon takes the installer to a screen which allows the installer to configure the reaction of the controlled outlet to security zones. From this screen the installer may scroll through the programmed security zones with the arrow icons. The installer may customize the reaction of the controlled outlet by setting a time frame, i.e. ‘From’ and ‘To’, during which the outlet will react, and by setting the power status and the duration that the outlet will remain in this power status upon reacting to a zone. Selection of the ‘X-10’ icon takes the installer to the screen from which the installer codes the controlled outlet to the proper PLC address.

Returning to the installer configuration screen, selection of the ‘HVAC’ icon takes the installer to the heating and cooling controls configuration screens of the system so that the installer can establish the proper HVAC settings for the end-user. Selection of the ‘Relays’ icon takes the installer to the relay control configuration screens of the system so that the installer can establish the proper settings for the relays that are interacting with auxiliary devices in the system. Selection of the ‘Sunriset’ icon takes the installer to the sunrise/sunset configuration screen, which allows the installer to program the exact geographic position of the system on the earth through latitude and longitude and the proper time zone. From this information the system maintains the correct sunrise and sunset information for display to the user. Selection of the ‘Tools’ icon takes the installer to the system tools screen, which allows the installer to reach an X-10 transmit screen to facilitate the installation of the system. Selecting the ‘X-10’ icon on this screen takes the installer to a screen that allows the installer to select specific X-10 codes to transmit through the building power line to confirm proper installation and function of certain devices, and to program the address into other devices. For example, the installer may broadcast an “A1” command to ensure that a controlled light is functioning properly, or the installer may assign an address to a switch that can only be programmed through the receipt of an X-10 signal.

VI. System Software

System 10 preferably includes asynchronous transfer linking-all-systems (ATLAS) software which has the same programming functionality as that obtained through touchscreen 28, with additional features. ATLAS software is programmed with suitable code known to those of skill in the art, such as C++ and JAVA code. ATLAS software is used by the installer of the system to run diagnostics on the installed system from a remote location. This is achieved by dialing into the system via a telephone line. The installer may also test or confirm system operation by dialing into the system and uploading the programming that the system is presently running. Problems can be solved remotely, and the programming file downloaded back to the system. ATLAS is also used to install upgrades or updates to the system. Programming for any system can be saved to a file in memory and downloaded to a second system in order to duplicate the same functionality on the second system.

Users can also use ATLAS software to customize programming already installed on the system. The user can perform customized programming of the system by linking an external personal computer through the RS 232 interface 14 (see FIG. 1). The user can also perform customized programming of the system by a remote computer by dialing into the system via a telephone line.

Installers and users of the system interact with ATLAS software on the computer through a series of graphical user interface screens (GUIs). Representative GUIs that function in accordance with the principles of the present invention are set forth in U.S. Provisional Patent Application Ser. No. 60/339,511 entitled, “Building Automation and Control System”, filed on Oct. 22, 2001, and are incorporated herein by reference. It will be understood by those of skill in the art that fewer or more screens can be included and the same or similar results accomplished.

The ATLAS software is programmed to accept input from users whose names and passwords are saved in an ATLAS programming file. A “super” user has control over the addition or deletion of all other users. Once a user is entered into the system for access, the user accesses the system by entering their name and password. Access by an installer to particular customers is provided through a GUI that allows the installer to open a particular customer file that provides the customer name, telephone number, and address. The installer can also add and delete customers from the list of customers via a database icon.

Once into the system, the main menu screen is displayed. Selection of the audio icon from the main menu opens a screen where the user selects which zone to program, and programs that zone. Selection of the lighting icon takes the user to a screen where the light to be controlled is selected. Another screen then allows the user to set the light illumination. Selecting the relay icon from the main menu opens a screen where the user chooses the relay to program, and sets that relay. Selecting the outlet icon from the main menu opens a screen where the user selects the outlet to program, then programs that outlet.

Selecting the security icon from the main menu opens a screen with a list of security options. The user selects the security option then arms or disarms that option. Selecting the energy icon from the main menu opens the energy management scenes screen. From this screen the user can modify a selected scene and/or activate a selected scene. If the user selects the ‘Modify’ icon, the modify scene screen opens where the user can rename the scene, delete the chosen scene, or add the following functions to the scene: audio, HVAC, lighting, outlets, relays, and security. The user can also specify that the scene run based upon a trigger. Selection of the ‘Trigger’ icon opens a screen where the user configures the trigger.

Selection of the program icon from the main menu opens a user programming screen. Selecting options from this screen opens a screen where the user can select operational options for the system. Selecting setup opens a screen that takes the user to the following: audio settings; date and time settings; deterrence settings; telephone settings; power management settings; and security settings. Security settings include: system codes, edit system code and determine code type, add system code and determine code type, selection of delay settings, system keys, add system key, and panic settings.

Returning to the main menu, selection of the schedules icon opens the appropriate screen or screens to add, edit, or delete a schedule for a system.

Selection of the scenes icon from the main menu opens a screen where the user can modify or activate a particular scene by incorporating any, or a combination of, the following functions: audio, HVAC, lighting, outlets, relays, and security. Triggers for a scene can also be entered.

Selection of the HVAC icon from the main menu opens a screen of which lists the HVAC zones in the building. After selecting the HVAC zone to configure, the user is taken to a screen to set parameters for that HVAC zone.

Selection of the installer icon from the main menu opens the installer programming screen. Selection of any of the items from the installer programming screen opens the associated screen for programming that item, such as audio zones and audio sources, lighting and outlets. The ‘Sunrise Sunset’ items on these screens allow the installer to designate whether the subsystem will react to a sunrise or sunset event.

Relays are also programmable by the installer. The installer can designate the “attribute” for a particular relay, such as what device the relay will control: auxiliary, camera, fireplace, garage, gate, pool spa or sprinkler. Security zones are added, edited, and deleted by the installer via another screen. The installer can name the security zone, select the zone mode—normally open, normally closed, or end-of-line, as well as whether the zone is bypassable. The zone type and zone attributes are also input by the installer. Zone types include: delay1, delay2, instant, follower, interior, tamper, fire, medical, police or inactive. Attributes include: door, window, motion, glass, gas, water, freeze and heat.

Sunrise and sunset time functions are programmed by the installer by entering the Greenwich Mean Time (GMT), latitude and longitude via the sunrise/sunset screen. Selection of system setup from the installer programming screen and subsequent selection of ‘status’ opens a screen which displays the status of the system. Selection of touchscreen from the installer programming screen allows the installer to program one or more touchscreens. The installer can rename the touchscreen and designate HVAC and audio zones if the particular touchscreen is to be used for either of these systems.

Once the user, or the installer, has finished diagnostics and/or programming of the system, any modifications made can be saved by selecting the save changes icon on the main menu screen. At that time the modifications are transmitted to the system via the telephone line or RS 232 port on the system platform, and/or saved for future installations.

VII. Example Functioning of the System

The number of functions that system 10 can perform in controlling and automating a building are nearly limitless. Several examples are presented for purposes of illustrating the operation of the system.

### EXAMPLE 1

Depending upon which “smart” key is used to unlock the door and disarm the security system, a message will appear on the general information screen of the touchscreen in the event that the user has email or a voice message waiting.

### EXAMPLE 2

In the event of a fire, all lights turn on to light a safe pathway, the HVAC turns off to prevent the transfer of smoke, and the outdoor lights flash to signal for help.

### EXAMPLE 3

Arming the security system automatically locks the doors and shuts overhead garage doors if left open. Disarming the building, such as a store, with a “smart” key automatically turns on all lights, turns on a neon “open” sign, adjusts the temperature and starts background music playing in the lobby.

### EXAMPLE 4

The HVAC system only cools or heats areas of the building that are occupied with motion. Or, when the security system is armed and the building is unoccupied, lights automatically turn off, the temperature adjusts for maximum energy savings, and the outlets to dangerous appliances such as coffee pots and toasters are turned off.

### EXAMPLE 5

Using a “smart” key to disarm the security system and unlock the front door also sets the temperature, music, lights, and other appliances to that particular users preferred settings. The key assigned to the housekeeper or maintenance person only works to unlock the door and disarm the security system during the day and time specified by the user.

### EXAMPLE 6

Audio sources such as compact disc players and radio stations are only played in rooms that are occupied via motion detection.

### EXAMPLE 7

One touch of a user defined icon such as “Party” or “Relax” automatically adjusts the lights, turns on the gas fireplace, adjusts the temperature, and starts playing appropriate music as selected by the user, in select areas of the building.

### EXAMPLE 8

The user selects a kWh or dollar value for the monthly electricity budget, assigns the priority level of the air conditioner and other appliances so that electricity usage never exceeds the budgeted amount specified by the user, or triggered by the utility.

### EXAMPLE 9

Telephone is disabled from ringing in the master bedroom while “Goodnight” scene is active based on user-selected parameters.

### EXAMPLE 10

The system will call four preset telephone numbers to deliver alert messages when the security system is violated, or smoke is detected, or the temperature is too high or low, or a key or code is or is not used at, or by, a selected time.

### EXAMPLE 11

The system downloads local weather and traffic and determines if “Wakeup” scene needs to run earlier than 6am based on user-selected parameters.

### EXAMPLE 12

From across the country the user views, changes or controls any system feature in a building via laptop computer or PDA.

### EXAMPLE 13

The user connects to the office building from home to view, change or control the temperature, locks security system, etc. of the office building, with ATLAS installed on the user's home computer and access to the Internet.

### EXAMPLE 14

A preset email message is delivered to a parent's computer at work when a child arrives home and uses a “smart” key to disarm and unlock the door. If child does not arrive home by the predetermined time, a preset email message is delivered every 15 minutes to the parent until the child arrives home.

### EXAMPLE 15

With one-touch press of the user-defined icon “Movie”, television channel is changed to channel 3, the surround sound amplifier and processor are turned on to volume level 8, all lights dim to 40%, door camera is shown on picture-in-picture on television, chime is disabled, living room window coverings are closed, and “play” command is sent to the DVD player.

VIII. Additional Components

Additional components of the present invention include, but are not limited to the following.

FIG. 34 illustrates an HVAC expansion card which can add up to two zones of single stage HVAC, heat pump or radiant heat control. This may be utilized with a touch screen or remote temperature sensor for each additional zone.

FIG. 35 illustrates an audio interface, pre-production interface used with an amplifier (e.g., a Russound 6-zone, 4-source amplifier) to provide integrated whole house audio through the system of the present invention.

FIG. 36 illustrates a remote temperature card and sensor. The remote temperature card provides multiple (e.g., up to 8 zones) of remote temperature sensing. It preferably includes at least one sensor.

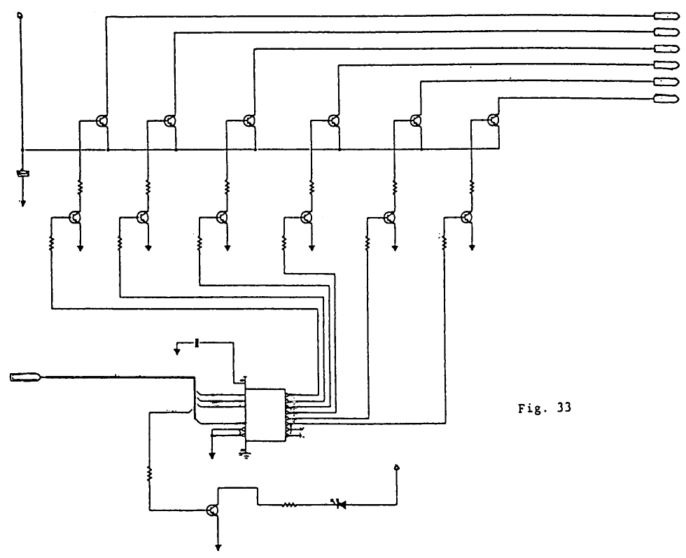

FIG. 37 illustrates a remote temperature sensor. Multiple sensors (e.g., up to 8 sensors) can be used with each remote temperature card. Sensors are used for indoor or outdoor temperature triggers for various scenes.

FIG. 38 illustrates a fanless power supply to enable “fanless” operation of the system of the present invention.

Although the invention has been described in detail with reference to this preferred embodiment, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A building automation and control system comprising:
an open architecture system platform in direct communication with a plurality of subsystems or devices located in proximity to a building;
a smart card in communication with said system platform for control of said system platform, subsystems or devices, said smart card comprising a programmable microprocessor; and
a touchscreen for user-interface with said system platform.

2. The building automation and control system of claim 1 further comprising:
a smart key for interfacing with said system platform, said smart key comprising a communication button for transmitting an encoded signal; and
a key reader for receiving the encoded signal from said communication button when said communication button is in proximity to said key reader, said key reader in communication with said system platform.

3. The building automation and control system of claim 1 further comprising at least one communication interface selected from the group consisting of telephone modem, radio frequency receiver/transmitter, infrared receiver transmitter, RS 232 interface, RS 485 interface, data bus interface, and PLC interface.

4. The building automation and control system of claim 3 further comprising software for programming said system remotely via said communication interface.

5. A smart key access apparatus for access to a building, said smart key access apparatus comprising:
a smart key comprising a button for transmission of an encoded signal;
a cradle comprising a ground contact and a power contact, said cradle for providing power to said smart key and receiving the smart key encoded signal upon placement of said smart key in said cradle; and
an interface for transmission of the encoded signal to a building automation and control system.

6. The smart key reader of claim 5 further comprising at least one device selected from the group consisting of an LED for visual alert to a user of the key reader and an audible signaling device for audible alert to a user of the key reader, said LED and said audible signaling device controlled by the building automation and control system.

7. A method of providing building automation and control comprising the steps of:
providing a programmable microprocessor on a system platform;
controlling building subsystems and devices with the system platform;
communicating at least one signal protocol selected from the group consisting of RS 232, RS 485, telephone line, data bus, and PLC to and from the system platform.

8. The method of claim 7 further comprising interfacing with the system platform with at least one interface selected from the group consisting of a touchscreen and a smart key access apparatus.

9. The method of claim 7 wherein the step of controlling building subsystems and devices comprises controlling at least one subsystem or device selected from the group consisting of HVAC subsystems, audio subsystems, relays, switches, security subsystem, audio devices, lighting, power outlets, motorized control devices, solenoids, transducers, and further comprising the step of interfacing with sensing devices.

10. The method of claim 7 further comprising the step of providing at least one information selected from the group consisting of information logs, energy management information, messaging information, and time and task management information on a screen in communication with the system platform.

11. An automated system comprising:
a main panel comprising a smart card;
a plurality of distributed touchscreens electrically connected to said main panel, at least one of said touchscreens capable of displaying a temperature; and
a temperature sensing element disposed substantially within at least one of said touchscreens.

12. An automated system comprising:
a smart card;
one or more user interfaces physically remote from and electrically connected to said smart card, said user interfaces comprising an iconic touchscreen; and
at least one element selected from the list consisting of security keypad, scene keypad, audio remote control, audio keypad, video remote control, video keypad, family scheduler, multiple palm pilot synchronizer, multiple personal digital assistant synchronizer, individual email monitor, lighting control keypad, appliance control keypad, energy usage display, and message delivery system.

13. An automated method for reacting to a fire comprising the steps of automatically turning on all interior lights;
automatically turning off heating, ventilation, and air-conditioning;
automatically activating an alarm;
automatically activating exterior lights; and
automatically calling a predetermined number.

14. An automated method for notifying a first person of another person's arrival at a building comprising the steps of:
detecting the arrival when the other person's smart key is used; and
notifying the first person of the other person's arrival.

15. The method of claim 14 wherein the notifying step comprises sending an e-mail to an e-mail address indicating arrival of the other person.

16. An automated method for notifying a first person of another person's failure to arrive at a building by a predetermined time comprising the steps of:
determining at the predetermined time if the other person has arrived at the building; and
notifying the first person if the other person has not arrived at the building.

17. The method of claim 10 wherein the information is particular to an identified user.

18. A method for automatically controlling a heating, ventilation, and air conditioning system comprising:
detecting an opening of a door or window; and
automatically adjusting the system in a vicinity of the detected opening.

19. The automated system of claim 11 comprising up to twelve touchscreens.

20. The automated system of claim 11 wherein said touchscreens receive power from the main panel.

21. The method of claim 8 further comprising the step of identifying a location or activity of a particular individual.

22. The method of claim 21 further comprising the step of automatically adjusting a temperature setting based on a preference of the individual.

23. The method of claim 21 further comprising the step of automatically adjusting lighting based on a preference of the individual.

24. The method of claim 21 further comprising the step of automatically adjusting one or more control devices based on a preference of the individual.

25. The automated system of claim 11 wherein at least one of said touchscreens comprises an infrared port.

26. A method for providing automatic building control comprising the steps of:
providing at least one smart key corresponding to a particular user;
providing at least one smart key reader;
providing a building control system comprising a smart card, said system receiving information from said key reader; and
wherein an adjustment is made by the control system to one or more elements selected from the list consisting of heating temperatures, cooling temperatures, lighting, audio, control devices and combinations of these based on programming for the particular user.

27. An automated system comprising:
a main panel comprising a smart card;
a plurality of user interfaces physically separated from but electrically connected to said main panel, said interfaces selected from the list consisting of one or more touchscreens having a temperature sensor disposed therein, one or more smart key readers, and combinations thereof.

28. A method for preventing damage to a processor of an automated building control system comprising the steps of:
providing an automated building system comprising a main panel;
providing one or more access points to said main panel; and
disposing said one or more access points remote from said main panel.
